(19) United States
(12) Patent Application Publication
(10) Pub. No.: US 2025/0307775 A1
(43) Pub. Date: Oct. 2, 2025

(54) Computing System and Method for Creating and Executing Attribute-Specific Predictive Analytics Pipelines for a Construction Project

(71) Applicant: Procore Technologies, Inc., Carpinteria, CA (US)

(72) Inventors: Joshua Alexander Newland, Walnut Creek, CA (US); Catherine Knuff, Brooklyn, NY (US); Tracy Rohlin, San Jose, CA (US); Ripple Goyal, Santa Clara, CA (US)

(21) Appl. No.: 18/619,072

(22) Filed: Mar. 27, 2024

(51) Int. Cl. G06Q 10/10; G06Q 50/08

(52) U.S. Cl. CPC G06Q 10/103; G06Q 50/08

(57) ABSTRACT

An example computing platform is configured to: (i) detect a trigger event for determining a value of a given project attribute for a given construction project having a stored set of project attribute data; (ii) in response to detecting the trigger event, execute an attribute-specific set of one or more predictive analytics pipelines for predicting one or more values of the given project attribute based on respective sets of source data for the one or more predictive analytics pipelines; and (iii) update the stored set of project attribute data for the given construction project based on the one or more values of the given project attribute that are predicted for the given construction project.

### BACKGROUND

Increasingly, parties involved in construction projects are beginning to use advanced software applications to manage those construction projects. One example of such an advanced software application is the software-as-a-service (SaaS) application for construction management offered by Procore Technologies, Inc. (“Procore”), who is the current applicant. Using construction management software applications such as these, parties can create a digital representation of each construction project that is to be managed and then create and store various types of project data in association with those digital project representations. Such project data may include digital documents such as specifications, drawings, or the like, which may be uploaded to the digital project representation, as well as various other types of digital data objects that may be created within the construction management software application, such as requests for information (RFIs), punch lists (e.g., which list work that has not yet been completed or has been completed incorrectly), and daily logs (e.g., which record information about each day work is done at a work site of the construction project), among many other examples of project data that may be stored for a construction project.

### Overview

Disclosed herein is a new technology for is new software technology for predicting the values of project attributes for a construction project with increased accuracy, efficiency, and/or adaptability. At a high level, the disclosed software technology may involve technology for creating and executing attribute-specific sets of one or more predictive analytics pipelines for a group of project attributes of interest, where each such predictive analytics pipeline functions to predict a respective value of a given project attribute for a construction project. The attribute-specific sets of one or more predictive analytics pipelines that may be created and executed in accordance with the present disclosure may take any of various forms.

In one aspect, the disclosed technology may take the form of a method to be carried out by a computing system that involves (i) detecting a trigger event for determining a value of a given project attribute for a given construction project having a stored set of project attribute data; (ii) in response to detecting the trigger event, executing an attribute-specific set of one or more predictive analytics pipelines for predicting one or more values of the given project attribute, wherein each respective predictive analytics pipeline in the attribute-specific set of one or more predictive analytics pipelines comprises respective pre-processing logic and a respective artificial intelligence (AI) model, and wherein each respective predictive analytics pipeline in the attribute-specific set of one or more predictive analytics pipelines, when executed, functions to: (a) obtain a respective set of source data for the given construction project; (b) apply the respective pre-processing logic of the respective predictive analytics pipeline to the respective set of source data for the given construction project and thereby derive a respective set of input data for the respective AI model of the respective predictive analytics pipeline; (c) provide the respective set of input data as input to the respective AI model of the respective predictive analytics pipeline and thereby cause the respective AI model to output a respective prediction based on the respective set of input data; and (d) based on the respective prediction that is output by the respective AI model of the respective predictive analytics pipeline, determine and output a respective value of the given project attribute for the given construction project; and (iii) updating the stored set of project attribute data for the given construction project based on the one or more values of the given project attribute that are predicted for the given construction project.

In some examples, the given project attribute comprises one of (i) a project title, (ii) a project description, (iii) a project address, (iv) a project area, (v) a project type, (vi) an occupancy code, (vii) a construction type, (viii) a work type, (ix) a number of total floors, (x) a number of floors above ground, (xi) a number of floors below ground, or (xii) a number of units.

Further, in some examples, for each respective predictive analytics pipeline in the attribute-specific set of one or more predictive analytics pipelines, the respective set of source data comprises at least one of (i) a set of one or more drawings for the given construction project, (ii) set of one or more specifications for the given construction project, or (iii) one or more types of project attributes data for the given construction project.

Still further, in some examples, for each respective predictive analytics pipeline in the attribute-specific set of one or more predictive analytics pipelines, the respective pre-processing logic comprises at least one of (i) pre-processing logic for extracting textual elements from a set of one or more drawings or (ii) pre-processing logic for extracting textual elements from a set of one or more specifications.

Still further, in some examples, for each respective predictive analytics pipeline in the attribute-specific set of one or more predictive analytics pipelines, the respective AI model comprises an AI model that is based on one of (i) a generative artificial intelligence (AI) model, (ii) a discriminative AI model, or (iii) a rules-based model.

Still further, in some examples, the generative AI model comprises either a Bidirectional Encoder Representations from Transformers (BERT) model or a Generative Pre-trained Transformer (GPT) model.

Still further, in some examples, the generative AI model comprises a pre-trained model that has been fine-tuned for predicting a value of the given project attribute based on training data.

Still further, in some examples, the discriminative AI model comprises either a decision-tree model or a computer-vision model that has been trained using a machine-learning process.

Still further, in some examples, the respective AI model for at least one respective predictive analytics pipeline in the attribute-specific set of one or more predictive analytics pipelines is remotely hosted by a separate computing platform.

Still further, in some examples, the attribute-specific set of one or more predictive analytics pipelines comprises multiple predictive analytics pipelines that are each configured to predict a respective value of the given project attribute, wherein the multiple predictive analytics pipelines comprise different types of AI models.

Still further, in some examples, at least one respective predictive analytics pipeline in the attribute-specific set of one or more predictive analytics pipelines comprises respective post-processing logic that is to be applied to the respective prediction output by the respective AI model of the at least one respective predictive analytics pipeline.

In yet another aspect, disclosed herein is a computing platform that includes at least one communication interface, at least one processor, at least one non-transitory computer-readable medium, and program instructions stored on the at least one non-transitory computer-readable medium that, when executed by the at least one processor, cause the computing platform to carry out the functions disclosed herein, including (but not limited to) any of the functions of the foregoing methods.

In yet another aspect, disclosed herein is a non-transitory computer-readable medium provisioned with program instructions that, when executed by at least one processor, cause a computing platform to carry out the functions disclosed herein, including (but not limited to) any of the functions of the foregoing methods.

One of ordinary skill in the art will appreciate these as well as numerous other aspects in reading the following disclosure.

### BRIEF DESCRIPTION OF THE DRAWINGS

FIG. 1 depicts an example network configuration in which examples described herein may be implemented.

FIG. 2 depicts a conceptual illustration of one example of a predictive analytics pipeline for determining which value or values to predict for a project attribute of a project in accordance with the present disclosure.

FIGS. 3A-B depict block diagrams that illustrate several example sets of attribute-specific predictive analytics pipelines in accordance with the present disclosure.

FIG. 4 depicts example functionality that may be carried out in order to create a predictive analytics pipeline for a given project attribute in accordance with the present disclosure.

FIG. 5 depicts example functionality that may be carried out in order to predict one or more values for a given project attribute utilizing an attribute-specific set of one or more predictive analytics pipelines in accordance with the present disclosure.

FIG. 6 is a simplified block diagram that illustrates some structural components that may be included in an example computing platform, according to the present disclosure.

FIG. 7 is a simplified block diagram that illustrates some structural components that may be included in an example client device, according to the present disclosure.

### DETAILED DESCRIPTION

The following disclosure refers to the accompanying figures and several examples. A person of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, parties involved in construction projects are increasingly beginning to use advanced software applications to manage those construction projects. One example of such an advanced software application is the software-as-a-service (SaaS) application for construction management offered by Procore Technologies, Inc. (“Procore”), who is the current applicant. Using construction management software applications such as these, parties can create a digital representation of each construction project that is to be managed and then create and store various types of project data in association with those digital project representations. Such project data may include digital documents such as specifications, drawings, or the like, which may be uploaded to the digital project representation, as well as various other types of digital data objects that may be created within the construction management software application, such as requests for information (RFIs), punch lists (e.g., which list work that has not yet been completed or has been completed incorrectly), and daily logs (e.g., which record information about each day work is done at a work site of the construction project), among many other examples of project data that may be stored for a construction project.

In practice, when creating a new digital representation of a construction project using a construction management software application such as Procore's, the user may be presented with an interface comprising various input/output (I/O) elements (e.g., text fields, check boxes, radio buttons, and/or other elements through which users can indicate values) for populating certain attributes of the construction project, such as a project title, a project type, a project address, a project area (e.g., square footage), and a project description, among other possible project attributes that can be input by the user when creating a new digital representation of a construction project within a construction management software application, and this project attribute data may then be stored as part of the digital representation of the construction project. In turn, the stored project attribute data for a construction project may be used for various purposes. For instance, as one possibility, the project attribute data for a construction project may be indexed and used to facilitate searching by construction professionals within the construction management software application, which may provide a construction professional with rapid access to information of interest electronically (e.g., via a lookup operation, a keyword search, a database query, or some other type of information retrieval functionality that the construction management software application is configured to support). As another possibility, the project attribute data for a construction project may be provided as input to software that is configured to generate predictive insights and/or benchmarks about construction projects.

However, the project attribute data that is entered for a construction project is frequently incomplete, inaccurate, and/or entered in an unstandardized format. For example, for some project attributes, users who are in a hurry or who are unsure of what the correct values of those attributes should be may omit entering values entirely if the interface allows them to do so. As another example, users may enter values that are inaccurate or incomplete (e.g., due to typographical errors or misunderstandings regarding what the value of the project attribute should be). As yet another example, in some cases, a user may provide a correct value in an incorrect format due to a lack of awareness about the format that the construction management software is configured to expect for a particular project attribute. As a further example, the construction management software application may not be set up to allow users to input values for certain project attributes that, if entered, would provide value to users of the construction management software application.

Unfortunately, existing construction management software applications generally do not include any functionality for verifying that the project attribute data being entered for a construction project is complete, accurate, and in the proper format, let alone functionality for determining and automatically populating values of the project attributes for a construction project. As a result, the project attribute data that is stored for construction projects today tends to be unreliable, which limits the usefulness of that data. For instance, because the project attribute data for a construction project is often incomplete, inaccurate, and/or in an unstandardized format, this may degrade the reliability and usefulness of searches that are conducted based on the project attribute data, predictive insights and benchmarks that are generated based on the project attribute data, or other tasks that are performed based on the project attribute data, which negatively impacts the user experience for a construction management software application.

Moreover, functionality for determining values of project attributes for a construction project is not trivial because the values might not be explicitly stated anywhere in the stored project data for the construction project. And even if those values are explicitly stated somewhere in the stored project data, those values might be stated in an unexpected location or written in an unexpected way such that a hard-coded parser may fail to recognize them. This problem is compounded by the fact that digital documents often do not fully conform to any standardized format or template, so even when the values of certain project attributes of interest are buried somewhere in the unstructured data of a document, existing construction management software applications lack a way to parse those values out of the unstructured data with sufficient accuracy.

To address these and other technical problems that arise in the context of construction management software applications, disclosed herein is new software technology for predicting the values of project attributes for a construction project with increased accuracy, efficiency, and/or adaptability. At a high level, the disclosed software technology may involve technology for creating and executing attribute-specific sets of one or more predictive analytics pipelines for a group of project attributes of interest, where each such predictive analytics pipeline functions to predict a respective value of a given project attribute for a construction project. The attribute-specific sets of one or more predictive analytics pipelines that may be created and executed in accordance with the present disclosure may take any of various forms, which may depend in part on the type of project attribute that the given predictive analytics pipeline is configured to predict.

Project attribute values that are predicted by the disclosed predictive analytics pipelines may then be used for various purposes. For instance, the predicted values of the attributes may be stored as part of the digital representation of the corresponding project. Furthermore, the predicted values may be used as input for a downstream process such as a model training process or even as source data for subsequent pipeline execution phases.

In practice, the disclosed software technology may either be integrated into a construction management software application or provided as a standalone software tool, among other possibilities. For instance, as one possible implementation, the disclosed software technology may be integrated into a construction management software application comprising both front-end client software running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software. As another possible implementation, the disclosed software technology may be integrated into a construction management software application comprising front-end client software that runs on client devices without interaction with a back-end platform. These software applications may take other forms as well.

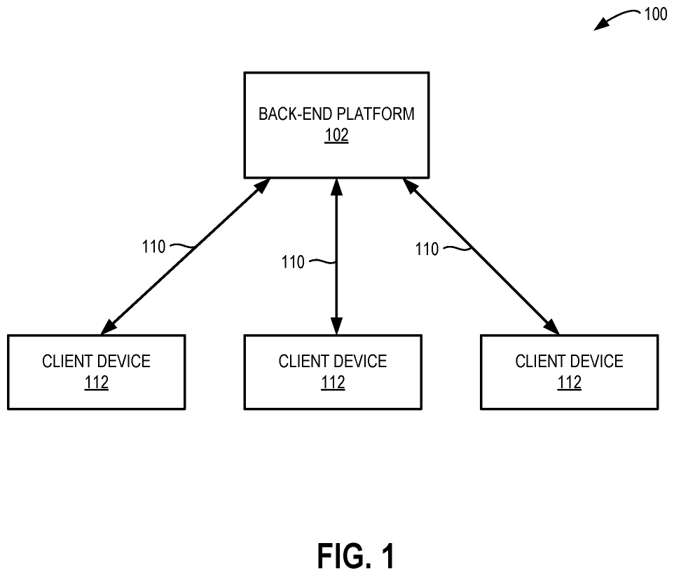

Turning now to the figures, FIG. 1 depicts an example network configuration 100 in which examples of the present disclosure may be implemented in connection with a construction management software application. As shown in FIG. 1, the network configuration 100 includes a back-end computing platform 102 that may be communicatively coupled to one or more client devices 112. Although the client devices 112 are depicted by three stations as shown for the sake of simplicity in illustration, it should be understood that the client devices 112 may represent more or less than three stations without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of back-end computing platform 102 may take various forms and may be arranged in various manners.

For instance, as one possibility, the back-end computing platform 102 may comprise computing infrastructure of a public, private, and/or hybrid cloud (e.g., computing and/or storage clusters) that has been provisioned with software for carrying out one or more of the functions disclosed herein. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with software for carrying out one or more of the functions disclosed herein. Other implementations of the back-end computing platform 102 are possible as well.

In turn, the client devices 112 may each be any computing system that is capable of running front-end software for a construction management software application, which may include program code for carrying out the client-side functions disclosed herein. In this respect, the client devices 112 may each include hardware components such as a processor, data storage, a user interface, and a network interface, among others, as well as software components that facilitate the client device's ability to run the front-end software disclosed herein (e.g., operating system software, web browser software, etc.). As representative examples, the client devices 112 may each take the form of a desktop computer, a laptop, a netbook, a tablet, a smartphone, and/or a personal digital assistant (PDA), among other possibilities.

As further depicted in FIG. 1, the back-end computing platform 102 is configured to interact with the client devices 112 over respective communication paths 110. In this respect, each communication path 110 between the back-end computing platform 102 and one of the client devices 112 may generally comprise one or more communication networks and/or communications links, which may take any of various forms. For instance, each respective communication path 110 with the back-end computing platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 110 with the back-end computing platform 102 may be wireless, wired, or some combination thereof, and may carry data according to any of various different communication protocols. Although not shown, the respective communication paths 110 between the client devices 112 and the back-end computing platform 102 may also include one or more intermediate systems. For example, it is possible that the back-end computing platform 102 may communicate with a given client devices 112 via one or more intermediary systems, such as a host server (not shown). Many other configurations are also possible.

Although not shown in FIG. 1, the back-end computing platform 102 may also be configured to receive data, such as data related to a construction project, from one or more external data sources, such as an external database and/or another back-end computing platform or platforms. Such data sources- and the data output by such data sources—may take various forms.

It should be understood that the network configuration 100 depicted in FIG. 1 is one example of a network configuration in which examples described herein may be implemented. Numerous other arrangements are possible and contemplated herein. For instance, other network configurations may include additional components not pictured and/or more or fewer of the pictured components.

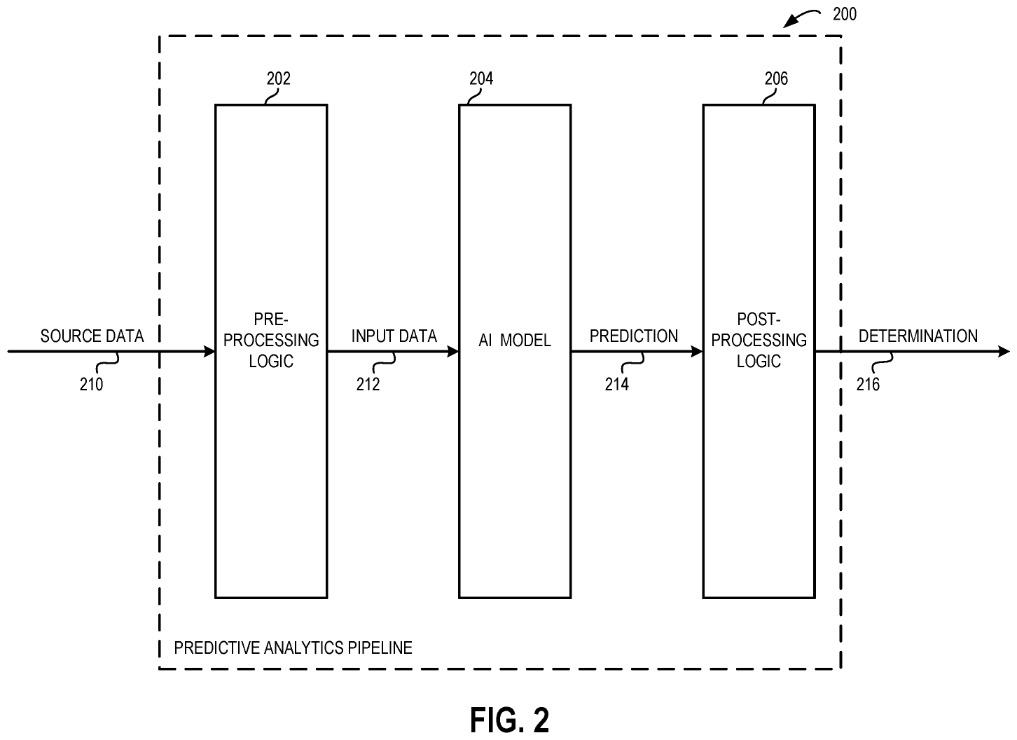

In line with the discussion above, the back-end computing platform 102 may be configured to create and execute attribute-specific sets of one or more predictive analytics pipelines for project attributes of interest, where each such predictive analytics pipeline functions to predict a respective value of a given project attribute for a construction project. Turning to FIG. 2, a conceptual illustration of one example of a predictive analytics pipeline 200 for predicting a value of a given project attribute for a construction project is depicted in accordance with the present disclosure. As shown in FIG. 2, the predictive analytics pipeline 200 may comprise pre-processing logic 202, an artificial intelligence (AI) model 204, and post-processing logic 206 that are configured to work together to predict a value of the given project attribute of interest for the construction project, which could take the form of a project title, a project description, a project address, a project area (including the unit of measurement for the project area), a project type, an occupancy code, a construction type, work type, a number of total floors, a number of floors above ground, a number of floors below ground, or a number of units, among other possibilities.

At a high level, the pre-processing logic 202 may function to (i) receive a given set of source data 210 that is provided as input to the predictive analytics pipeline 200 for the given project attribute and (ii) transform the given set of source data 210 into input data 212 for the AI model 204. In this respect, the given set of source data 210 that is provided as input to the predictive analytics pipeline 200 may comprise any type of source data that may provide insight regarding the value of the given project attribute. Such source data 210 could take any of various forms.

For instance, as one possibility, the given set of source data 210 may include one or more source documents for the construction project, such as one or more project drawings and/or one or more project specifications for the construction project. Project drawings may take many forms and may be stored in a variety of file formats. Some examples of forms that project drawings my take include architectural drawings, construction blueprints, floor plans, concept drawings, elevation drawings, presentation drawings, electrical drawings, structural drawings, detail drawings, installation drawings, firefighting drawings, roof slab layouts, site plans, mechanical drawings, Plinth beam layouts, HVAC (Heating, Ventilation, and Air Conditioning) drawings, foundation plans, landscape drawings, and views extracted from three-dimensional models of buildings (e.g., views extracted form Building Information Model (BIM) files or computer-aided design (CAD) files), to name a few. Such drawings may be stored in formats such as portable document format (PDF), scalable vector graphics (SVG), portable network graphics (PNG), graphics interchange format (GIF), tagged image file (TIFF), and Joint Photographic Experts Group (JPEG), to name a few. Other forms and formats are also possible. Project specifications may also take many forms and be stored in a variety of formats. Some examples of forms that project specifications might take include proprietary specifications, architectural specifications, performance specifications, prescriptive specifications, general specifications, and reference specifications, to name a few. Project specifications may be stored in file formats such as PDF, Microsoft Word (DOCX), OpenOffice Document (ODT), LaTeX (TEX), hypertext markup language (HTML), and plain text (TXT), to name a few. Project specifications may also take other forms and be stored in other formats.

As another possibility, the given set of source data 210 may include other information about the construction project, examples of which may include project attributes (e.g., project title, project description, project type, etc.) that have been input by a user or have been predicted beforehand by other predictive analytics pipelines and/or information that may be derived based on data that has been stored for the construction project, such as information regarding the types of drawings that have stored for the construction project (e.g., demolition, foundation, etc.), information regarding the particular trades on the construction project (e.g., site marking, excavating, welding, concreting, brick masonry, plastering, etc.), and/or information regarding activities related to the construction project (e.g., dates when daily logs, RFIs, meeting minutes, and other types of records associated with the construction project were created), among other possible examples. The given set of source data 210 may also take other forms.

As noted above, the pre-processing logic 202 of the predictive analytics pipeline 200 may function to transform the given set of source data 210 into the input data 212 for the AI model 204, which may also be referred to as “feature data” for the AI model 204. The pre-processing logic 202 may take any of various forms.

As one possibility, the pre-processing logic 202 may include logic to apply optical character recognition (OCR) to detect textual elements that are depicted in source documents comprising images and to convert the detected textual elements into a usable encoding (e.g., American Standard Code for Information Exchange (ASCII) or Unicode).

As another possibility, the pre-processing logic 202 may include logic to join (e.g., concatenate or merge) multiple textual elements together (e.g., multiple lines of text found in a source document) to create meaningful phrases based on a set of rules.

As yet another possibility, the pre-processing logic 202 may include logic to identify and extract textual elements found in a source document (e.g., a specification, a drawing, or some other type of document) that satisfy certain criteria. For example, the pre-processing logic 202 may include logic to identify textual elements that are located within a particular part of a source document, logic to identify textual elements that are in proximity to (e.g., within a threshold distance of) other identified textual elements within the source document, and/or logic to identify textual elements that are likely to represent a particular attribute of a source document (e.g., a document title). For example, the pre-processing logic 202 for identifying and extracting textual elements within a source document that satisfy certain criteria could include logic that utilizes predictive analytics to identify and extract a title of a source document that is a drawing. Further details regarding this type of logic are described in U.S. patent application Ser. No. 17/408,052, which was filed on Aug. 20, 2021 and is entitled “Machine-Learning-Based Identification of Drawing Attributes,” the contents of which are incorporated herein in their entirety.

As yet another possibility, the pre-processing logic 202 may include logic to identify textual elements found in a source document that match a predefined pattern. The predefined pattern may be encoded in a variety of ways (e.g., via one or more regular expressions, graphs, etc.) and may take any of various forms (e.g., such as the forms that are described in more detail further below with respect to several of the example predictive analytics pipelines).

As yet another possibility, the pre-processing logic 202 may include logic to identify and categorize named entities from amongst textual elements found in a source document (e.g., persons, organizations, locations, or other types of entities that may have names that are proper nouns), which is sometimes referred to as named entity recognition (NER). Such pre-processing logic 202 for performing NER may take any of various forms, examples of which may include logic for performing dictionary-based NER, rule-based NER, and/or machine-learning-based NER (including but not limited to deep-learning-based NER), among other possibilities.

As yet another possibility, the pre-processing logic 202 may include logic to vectorize textual elements found in a source document. For example, the pre-processing logic 202 may include a vector schema that defines a number of feature variables (e.g., dimensions) and an order in which those feature variables are to be arranged in vectors that conform to the vector schema. The pre-processing logic 202 may also include logic for deducing feature values for those feature variables based on a given textual element and generating a vector that stores those feature values in a vector that conforms to the order specified by the vector schema. The resulting vector is a vectorization of the given textual element. Both the vector schema and the logic for deducing feature values from a given textual element may take many forms. As one possibility, the functionality for vectorizing textual elements found in a source document may generate embeddings, encodings such as one-hot encodings, or some other type of embedding or encoding. The vector schema and the logic for deducing feature values may also take other forms.

As yet another possibility, the pre-processing logic 202 may include logic to analyze metadata for a source document to extract information that is likely to be relevant for predicting the value of the given project attribute, such as metadata of a project drawing that indicates the title of the drawing, the scale of the drawing, etc.

As yet another possibility, the pre-processing logic 202 may include logic for determining contextual information for certain textual elements that are identified within a source document, such as spatial information for an identified textual element (e.g., information that indicates a position, orientation, and/or size of a textual element identified within a drawing), linguistic information for an identified textual element (e.g., which parts of speech are included in the given textual element, how many of the different parts of speech are included in the given textual element, and/or what respective percentage of words in the given textual element are of each part of speech), and/or relational information for an identified textual element (e.g., information that indicates how a textual element identified within a drawing relates to other elements in the drawing), among other possible types of linguistic information.

As another possibility, the pre-processing logic 202 may include logic to apply other techniques to textual elements found in the source data 210. Such techniques may include, as some nonlimiting examples, correcting any spelling and/or grammatical errors, unifying, removing non-ASCII characters, removing stop words, lemmatizing, and analyzing sentiment.

The pre-processing logic 202 may also take other forms.

In turn, the AI model 204 may comprise any data science model that is configured to (i) receive the input data 212, (ii) evaluate the input data 212, and (iii) based on the evaluation of the input data 212, determine and output a prediction 214 that may be utilized to determine a value of the given project attribute. In accordance with the present disclosure, the input data 212 that is provided as input to the AI model 204, the prediction 214 that is output by the AI model 204, and the type of AI model 204 may each take any of various forms.

In general, the input data 212 may comprise any data that may be utilized by the AI model 204 to make a prediction related to a value of given project attribute. Depending on the given project attribute and the type of AI model 204, such input data 212 take any of various forms. For example, certain types of AI models (e.g., neural networks, regression models, etc.) may be configured to receive numeric values (e.g., discrete numeric values such as integers, continuous numeric values such as real numbers, etc.) that encode and quantify certain features determined from the given set of source data 210. As another example, certain types of AI models (e.g., certain rule-based models and certain decision-tree models) may be configured to receive categorical values that encode and classify certain features determined from the given set of source data 210. As still another example, certain types of AI models (e.g., LLMs) may be configured to receive textual data. It should also be understood that certain types of AI models may be configured to receive a combination of multiple different types of input data (e.g., both numerical values and categorical values).

Further, the prediction 214 that is output by the AI model 204 may take any of various forms. For instance, as one possibility, the prediction 214 that is output by the AI model 204 may take the form of a set of candidate values for the given project attribute along with corresponding confidence scores, which may then be analyzed by the post-processing logic 206 in order to determine one or more values for the given project attribute. To illustrate with an example, the AI model 204 may be configured to output a first predicted value along with a first confidence score, a second predicted value along with a second confidence score, and so on, which may be arranged in the form of a ranked list or the like. As another possibility, the prediction 214 that is output by the AI model 204 may take the form of a single, predicted value for the given project attribute, which may then be determined to be the value for the given project attribute without any further analysis. In this respect, the single predicted value may or may not be output along with a corresponding confidence score. As yet another possibility, the prediction 214 that is output by the AI model 204 may take the form of a predicted value for some other data variable (or a set of data variables), which may then be used by the post-processing logic 206 to determine one or more values for the given project attribute. The prediction 214 that is output by the AI model 204 may take other forms as well.

Further yet, the AI model 204 may comprise any of various different types of AI models. For instance, as one possibility, the AI model 204 may be based on a generative Artificial Intelligence (AI) model that can be used to perform a predictive task. The AI model could take any of various forms-including but not limited to any of various types of large-language models (LLMs).

As one particular example, the AI model 204 may be based on a type of LLM referred to as a Bidirectional Encoder Representations from Transformers (“BERT”) model, which was originally developed by Google®. A BERT model may be trained via a pre-training phase that involves unsupervised training (e.g., via contrastive divergence, Kullback-Leibler divergence, or another unsupervised training technique) on a large corpus of text (which is treated as unlabeled training data) in a natural language (e.g., English). A number of pre-trained BERT models are generally available in the industry (e.g., such as Google®'s pre-trained BERT model that can be downloaded via the Google® Research GitHub® repository). Such pre-trained models may, if desired, be installed and executed locally (e.g., within the back-end computing platform 102 of FIG. 1). Alternatively, such pre-trained models may be executed remotely and be accessed through a network via an application programming interface (API).

In general, a pre-trained BERT model may be sufficient to function as the AI model 204 without any additional training. However, if desired, an optional fine-tuning phase that involves supervised training (e.g., via backpropagation or another supervised training technique) on labeled training data may also be applied to further train a BERT model. In some cases, the optional fine-tuning phase of training may enhance the BERT model's capacity to predict the given project attribute. For instance, the optional fine-tuning phase may involve training the BERT model with training data that includes terminology specific to the construction industry in order to configure the BERT model to decipher construction-specific meaning from input (e.g., by adjusting weights, biases, and/or one or more probability distributions represented within the BERT model). In the optional fine-tuning phase, the BERT model is trained to evaluate textual elements using training data derived from historical projects and/or simulated projects whose values for the given project attribute are known (e.g., verified and treated as ground-truth data).

The training data for the optional fine-tuning phase may comprise a collection of training instances. Each given training instance may represent a given textual element found in one of the historical and/or simulated projects. Furthermore, each given training instance may comprise (i) feature values (e.g., actual parameters) that map to respective feature variables (e.g., formal parameters) which the BERT model is configured to receive as input and (ii) a label that indicates the value for the given project attribute of the project in which the given textual element represented by the given training instance is found. During the optional fine-tuning phase of training, the BERT model (i) receives each given training instance as input, (ii) predicts the value of the given project attribute based on the feature values of the given training instance, (iii) compares the predicted value of the given project attribute to the ground-truth value of the given project attribute indicated by the label of the given training instance, and (iv) adjusts model parameters (e.g., the weights and biases found in different layers of the BERT model) within the BERT model based on any difference that exists between the predicted value and the ground-truth value. If the number of training instances in the training data is sufficiently large (e.g., at least ten times the number of feature variables that the BERT model is configured to receive as input), the BERT model will converge to a state in which the BERT model will be able to predict the given project attribute based on the feature variables with increased accuracy.

As another particular example, the AI model 204 may be based on a type of LLM referred to as a Generative Pre-trained Transformer (“GPT”) model, which was originally developed by OpenAI®. Like the BERT model described above, such a GPT model may be trained via a pre-training phase that involves unsupervised training (e.g., via contrastive divergence, Kullback-Leibler divergence, or another unsupervised training technique) on a large corpus of text (which is treated as unlabeled training data) in a natural language (e.g., English). A number of pre-trained GPT models are generally available in the industry (e.g., such as OpenAIR's pre-trained GPT-2, GPT-3, and GPT-4 models that are available through the OpenAIR Platform). Such pre-trained models may, if desired, be installed and executed locally (e.g., within the back-end computing platform 102 of FIG. 1). Alternatively, such pre-trained models may be executed remotely and be accessed through a network via an application API.

In general, a pre-trained GPT model may be sufficient to function as the AI model 204 without any additional training. However, if desired, an optional fine-tuning phase that involves supervised training (e.g., via backpropagation or another supervised training technique) on labeled training data may also be applied to train a GPT model further. In some cases, the optional fine-tuning phase of training may enhance the GPT model's capacity to predict the given project attribute. In the optional fine-tuning phase, the GPT model is trained to predict values of the given project attribute based on text found in the given set of source data 210. The training data may comprise a collection of training instances. Each training instance may comprise (i) text found in a respective project and (ii) the ground-truth value of the given project attribute of the respective project. During the optional fine-tuning phase of training, the GPT model will (i) receive each given training instance as input, (ii) predict the given project attribute based on the general-division text found in the given training instance, (iii) compare the predicted value of the given project attribute to the ground-truth value of the given project attribute found in the given training instance, and (iv) adjust model parameters (e.g., the weights and biases found in different layers of the GPT model) within the GPT model based on any difference that exists between the predicted value and the ground-truth value. If the number of training instances in the training data is sufficiently large (e.g., at least fifty training instances), the GPT model will converge to a state in which the GPT model will be able to predict the given project attribute based on the feature variables with increased accuracy.

LLMs may be configured (e.g., via the fine-tuning phase) to determine different types of predictions. For instance, one type of prediction that a given LLMs can be configured to determine is text classification. Text classification involves categorizing textual input that the LLMs receives into a predefined set of possible classes. Configuring a BERT model (or a GPT model), for example, for text classification may be achieved by adding one or more layers (e.g., neural network layers, wherein each layer includes a plurality of respective nodes and the respective nodes in a given layer are each configured to receive inputs comprising the outputs of the respective nodes in a preceding layer) that are not present in a pre-trained version of the BERT model (or GPT model). The one or more layers are then trained (e.g., in a fine-tuning phase) to classify the textual input based on a vectorized representation of the textual input that is generated in the portion of the BERT model (or GPT model) that precedes the one or more added layers. Another type of prediction that a given LLMs can be configured to determine is textual similarity (e.g., semantic similarity or relatedness) between a pair comprising a first textual input and a second textual input. Configuring a BERT model (or GPT model), for example, for determining textual similarity may be achieved by adding one or more layers (e.g., neural network layers) that are not present in a pre-trained version of the BERT model (or GPT model). The one or more layers are then trained (e.g., in a fine-tuning phase) to determine textual similarity based on a vectorized representation of the pair that is generated in the portion of the BERT model (or GPT model) that precedes the one or more added layers. Some other types of predictions that LLMs may be configured to determine include question answering, coreference resolution, machine translation, summarization, text completion, and sentence completion. LLMs may also be configured to determine other types of predictions in a similar fashion.

The AI model 204 could also be based on other types of generative AI models as well.

As another possibility, the AI model 204 may be based on a discriminative AI model, which could take any of various forms-including but not limited to decision-tree model (e.g., a Random Forest model or a gradient-boosted decision tree (GBDT) model), a neural-network-based model (e.g., a feed-forward neural network or a recurrent neural network trained via backpropagation, a deep-belief network with layers that comprise restricted Boltzmann machines trained via contrastive divergence, Kullback-Leibler divergence, etc.), a regression model (e.g., derived via Lasso regression, logistic regression, linear regression, polynomial regression, etc.), a nearest-neighbor model (e.g., k-nearest neighbor, BallTree, KDTree, etc.), a support vector machine (SVM) model, and/or a Bayesian model (e.g., a Bayesian belief network), among other possibilities.

As one particular example, the AI model 204 may be based on an XGBoost model, which is one example of a GBDT model. The training data for the XGBoost model may comprise a collection of training instances. Each given training instance may comprise (i) feature values (e.g., actual parameters) that map to respective feature variables (e.g., formal parameters) which the XGBoost model is configured to receive as input and (ii) a label that indicates whether a given textual element (which is found in the given set of source data 210) represented by the given training instance is a value for the given project attribute. The XGBoost model may be trained in a series of iterations in the following manner.

In the first iteration, a base decision tree is generated based on a comparison between the training data (including the respective labels for the training instances) and one or more splitting criteria (e.g., Gini impurity, information gain, Chi-square, entropy, etc.). The base tree is added to the XGBoost model.

In the second iteration, the XGBoost model (which, at the beginning of this iteration, includes the base decision tree alone) is applied to each given training instance in the training data to determine a respective prediction of whether the given training instance represents a value for the given project attribute or not. Next, a respective residual is determined for each given training instance based on a comparison of the respective prediction to the respective label of the training instance. The respective residuals may be represented by numeric values (e.g., “0” if the respective prediction matches the respective label and “1” otherwise), Boolean values (e.g., “true” if the respective prediction matches the respective label and “false” otherwise), or categorical values (e.g., “match” if the respective prediction matches the respective label and “non-match” otherwise). Next, a residual decision tree is generated based on a comparison between the training data, the respective residuals, and one or more splitting criteria. Unlike the base decision tree, the residual decision tree is not configured to predict whether a given instance represents a value of the given attribute based on the feature values included in the given instance. Instead, the residual tree is configured to predict the base tree's residual for the given instance-in other words, to predict whether the XGBoost model (which, in its current state, still includes the base decision tree alone) would classify the given instance accurately. The residual decision tree is added to the XGBoost model.

In the third iteration, the XGBoost model (which, at the beginning of this iteration, includes both the base decision tree and the residual decision tree) to each given training instance in the training data to determine a respective prediction of whether the given training instance represents a value of the given project attribute or not. To determine the respective prediction, the XGBoost model (i) determines a preliminary prediction of whether the given training instance represents a value of the given project attribute or not by comparing the given training instance's feature values to the base decision tree and (ii) determines a predicted residual by comparing the given training instance's feature values to the residual decision tree. If the predicted residual indicates that the base decision tree likely predicted the label of the given training instance correctly, the XGBoost model assigns the preliminary prediction as the respective prediction. Otherwise, the XGBoost assigns a corrected prediction as the respective prediction. For example, if the preliminary prediction indicates that the given training instance represents a value of the given project attribute and the predicted residual indicates the preliminary prediction is likely incorrect, the corrected prediction would indicate that the given training instance does not represent a value of the given project attribute.

In subsequent iterations, the back-end computing platform 102 may generate additional residual decision trees and add those additional residual decision trees to the XGBoost model in a similar manner. The residual decision tree generated in any given iteration is configured to predict the residual of the version of the XGBoost model that existed at the end of the iteration that immediately precedes the given iteration.

The training for the XGBoost model may be considered complete once the XGBoost model includes a predefined number of trees or achieves a threshold level of prediction accuracy. If the number of training instances in the training data is sufficiently large (e.g., at least ten times the number of feature variables), the XGBoost model will converge to a state in which the XGBoost model will be able to predict whether a textual element found in the source data 210 is a value of the given project attribute accurately.

As another particular example, the AI model 204 may be based on a neural network that is configured to perform a computer-vision task (e.g., object detection, classification, segmentation, etc.), which is sometimes referred to as a “computer-vision model” (although it should be understood that computer-vision models are not limited to neural networks). The training data for the computer-vision model may comprise a plurality of training instances. Each given training instance may represent a respective project and may include (i) a plurality of feature values extracted from drawings included in the respective project via one or more computer-vision techniques for feature extraction (e.g., Speeded Up Robust Features (SURF), Scale-Invariant Feature Transform (SIFT), Oriented FAST and Robust BRIEF (ORB), etc.) and (ii) a label that indicates a ground-truth value about the respective project that is related to spaces depicted in the plurality of drawings. The training data may be derived from historical projects and/or simulated projects whose ground-truth values are known (e.g., verified and treated as ground-truth data). During training, the computer vision model will (i) receive each given training instance as input, (ii) predict a value about the respective project based on the features values extracted from the plurality of drawings found in the given training instance, (iii) compare the predicted value to the label found in the given training instance, and (iv) adjust model parameters (e.g., the weights and biases found in different layers of the computer-vision model) within the computer-vision model based on any difference that exists between the predicted value and the ground-truth indicated by the label. If the number of training instances in the training data is sufficiently large (e.g., at least fifty training instances), the computer-vision model will converge to a state of being able to predict the value about the respective project with increased accuracy. Note that if the neural network is a deep-belief network, a pre-training process may be applied to train one or more hidden layers of the neural network based on unlabeled training data via contrastive divergence. Also note that discriminative models other than neural networks may also function as computer-vision models if trained on the labeled training data described above.

The AI model 204 could also be based on other types of discriminative AI models, including but not limited to other types of decision-tree models, other types of neural networks (e.g., a neural network configured to perform text classification), and/or other types of computer-vision models.

As another possibility, the AI model 204 may be based on a rule-based model, which may generally comprise a model that encodes a set of rules. Each rule in the rule-based model may specify one or more conditions and a prediction value to be output when those conditions are satisfied. Optionally, if the rules in the set are defined in such a way that the respective one or more conditions for more than one rule may be satisfied concurrently, the rule-based model may include an order of precedence that specifies which of the rules whose respective one or more conditions are satisfied will apply.

The rule-based model may take various forms and may be generated in different ways. For example, the rule-based model may comprise a collection of user-defined rules that are defined by a user (e.g., by entering rule data through a user interface). In another example, the rule-based model may be an association-rule model that is generated by applying an association-rule training technique such as Frequent Pattern Growth (FP-Growth), Equivalence Class Transformation (Eclat), Apriori, or some other training technique for generating association rules. In yet another example, the rule-based model may be a hybrid model that includes both association rules generated via training and user-defined rules defined based on user input. The rule-based model may also take other forms.

As noted above, the rule-based model may be an association-rule model (or a hybrid model that comprises an association-rule model). In this scenario, an association-rule model for predicting the value of a given project attribute based on feature values (which may, for example, include values of other project attributes that are correlated with the given project attribute) may be trained in the following manner. The training data for the association-rule model may be derived from historical projects and/or simulated projects whose values for the given project attribute are known (e.g., verified and treated as ground-truth data). The training data may comprise a collection of training instances. Each given training instance may represent one of the historical and/or simulated projects. Furthermore, each given training instance may comprise (i) feature values derived from the given project represented by the training instance and (ii) a label that indicates the value of the given project attribute for the project represented by the training instance. Once the training data has been deriver, an association-rule training technique such as Apriori, FP-Growth, Eclat, or some other technique that is capable of detecting non-independence between the feature values and the given project attribute and leveraging that non-independence to create rules for predicting the value of the given project attribute based on the feature values is applied to train the association-rule model.

The AI model 204 may also take other forms.

Turning next to the post-processing logic 206, as shown, the post-processing logic 206 may be configured to receive the prediction 214 output by the AI model 204 and then perform certain post-processing operations based on the prediction 214, as appropriate, in order to determine and output a determination 216 (e.g., of one or more predicted values for the given project attribute). Depending on the given project attribute and the form of the prediction 214 output by the AI model 204, the operations that are performed by the post-processing logic 206 may take any of various forms.

As one possibility, if the AI model 204 is configured to output a set of candidate values for the given project attribute, the post-processing logic 206 may include logic for selecting one particular value from the set of candidate values output by the AI model 204 as the determined value for the given project attribute. For instance, in an example where the AI model 204 outputs a set of candidate values along with corresponding confidence scores, the post-processing logic 206 may include logic to select the candidate value having the highest confidence score as the determined value for the given project attribute, and that selected value may then be provided as the output of the predictive analytics pipeline 200.

As another possibility, the post-processing logic 206 may include logic for transforming the prediction 214 output by the AI model 204 into a standardized format that is to be utilized for the one or more values of the given project attribute. For instance, the post-processing logic 206 may include logic for removing newline characters, changing the case of certain letters, converting digits to words (e.g., “1” to “one”), etc.

As another possibility, the post-processing logic 206 may include logic for cleaning and/or completing text found in the prediction 214 output by the AI model 204. For instance, the post-processing logic 206 may include logic for correcting misspelled words, correcting grammatical errors, spelling out words represented by abbreviations, etc.

As another possibility, the post-processing logic 206 may include logic for performing additional operations based on the prediction 214 output by the AI model 204 in order to determine the one or more values of the given project attribute. For instance, in some configurations, the prediction 214 output by the AI model 204 may not itself constitute a predicted value of the given project attribute, but rather may constitute a value that is used as a basis for computing a value of the given project attribute. To illustrate with an example, a computer-vision model may be configured to output a prediction related to a drawing, such as prediction of which portions of the drawing constitute distinct rooms and/or a prediction of what floors are reflected in the drawing, but these predictions may not directly constitute values of any project attribute. Rather, additional computations may need to be performed based on these predictions in order to determine a value for the given project attribute.

The post-processing logic 206 may also take other forms. Further, it is possible that certain configurations of predictive analytics pipelines will not include any post-processing logic, such as configurations where the pipeline's AI model outputs a single, predicted value for the given project attribute and that predicted value is in a form that does not require any further processing in order to be utilized as the value of the given project attribute.

As noted above, the back-end computing platform 102 may be configured to create an attribute-specific set of one or more predictive analytics pipelines for each of one or more project attributes of interest, which each such predictive analytics pipeline generally takes the form of the example predictive analytics pipeline 200 shown and described with reference to FIG. 2. In this respect, an attribute-specific set of one or more predictive analytics pipelines for a given project attribute could either include a single predictive analytics pipeline for predicting a value of the given project attribute, or could include multiple predictive analytics pipelines that each function to predict a respective value of the given project attribute (e.g., predictive analytics pipelines comprising different types of AI models). As some representative examples, such an attribute-specific set of multiple predictive analytics pipelines could include (i) predictive analytics pipelines based on multiple different types of LLMs, (ii) predictive analytics pipelines that are respectively based on decision-tree and computer-vision models, (iii) predictive analytics pipelines that are respectively based on large-language, computer-vision, and rule-based models, and (iv) predictive analytics pipelines that are respectively based on large-language, decision-tree, computer-vision, and rule-based models, among other possible examples.

To illustrate further, some possible examples of the attribute-specific set of one or more predictive analytics pipelines that may be created in accordance with the present disclosure will now be described with reference to example types of project attributes.

### Project Title

Beginning with project title as a first type of project attribute, an attribute-specific set of one or more predictive analytics pipelines for predicting project title may include at least one predictive analytics pipeline that is based on a type of LLM, such as a first example predictive analytics pipeline for predicting project title that is based on a BERT model and/or a second example predictive analytics pipeline for predicting project title that is based on a GPT model that is configured for question answering. These examples of predictive analytics pipelines for predicting project title will now be described in further detail.

The source data for this first example predictive analytics pipeline may include drawings that are associated with a given construction project for which a project title is to be predicted. The pre-processing logic for this first example predictive analytics pipeline may identify textual elements in the drawings by identifying any searchable text (e.g., stored in ASCII or Unicode encodings) that exists in the drawings and by applying OCR to identify any text that is depicted in image form. Once the textual elements have been identified, the pre-processing logic may optionally include logic to exclude or discard any textual elements that are unlikely to contain a name of a person or a name of an organization. For example, the pre-processing logic may comprise a pre-trained BERT NER model that has been trained to identify names (e.g., such as an instance of the bert-base-NER model that is available through the Hugging Face® platform) to the textual elements. Any of the textual elements whose likelihood (e.g., as predicted by the BERT NER) of including a name fails to satisfy a predefined threshold condition may be discarded (and thereby excluded from further processing).

The pre-processing logic may further include logic to, for each given textual element, extract respective contextual data for the given textual element. The respective contextual data may take many forms. As one possibility, the respective contextual data may include spatial information, linguistic information, and/or relational information (e.g., that indicates how the given textual element relates to other elements in the drawing in which the given textual element is found).

In line with the discussion above, each type of contextual data may take various forms. For example, the spatial information may include information identifying a position of the given textual element in the drawing in which the textual element is found, such as a distance between the textual element and an edge of the drawing in which the given textual element is found, coordinates of one or more pixels of the given textual element, or any other spatial information indicating the position of the given textual element in the drawing. As another example, the spatial information may include information identifying an orientation of the given textual element, such as whether the given textual element is oriented vertically, horizontally, or at some other angle of rotation. As yet another example, the spatial information may include information identifying a size of the given textual element, such as a font size or a number of pixels along one or more dimensions of the given textual element. As yet another example, the spatial information may include information identifying spacing (e.g., kerning) between characters within the given textual element. The spatial information may also include any other spatial aspect of the given textual element that is predictive of whether the given textual element represents a project title.

In addition, the linguistic information may take various forms. For example, the linguistic information may include information identifying which parts of speech are included in the given textual element, how many of the different parts of speech are included in the given textual element, and/or what respective percentage of words in the given textual element are of each part of speech. Parts of speech may be indicated, for instance, by part-of-speech (POS) tags that a BERT NER model identifies for words in the given textual element. As yet another example, the linguistic information may include information identifying whether the given textual element includes any predefined stop words (e.g., words that are not typically found in project titles), such as “schematic,” and/or how many of these stop words are included in the given textual element. As still another example, the linguistic information indicated may include information identifying whether the given textual element is capitalized or whether the given textual element includes any numerical characters. As still another example, the linguistic information may include information indicating a typeface (e.g., bold, italic, etc.) of the given textual element and formatting (e.g., underlining, highlighting, etc.) of the given textual element. The linguistic information may also include other linguistic aspects of the given textual element that are predictive of whether the given textual element represents a project title.

Furthermore, the relational information may take various forms. For example, the relational information may include information about whether or not the given textual element is located inside a rectangular box or some other type of shape. As another example, the relational information may include information about whether any other textual elements are nearby (e.g., within a threshold distance of) the given textual element and/or whether these nearby textual elements include any words found in a predefined positive-correlation list (e.g., words that are typically found near project titles), such as “title” or “name.” The relational information may also include any other relational information about how the given textual element relates to surrounding elements in the drawing in which the given textual element is found.

The pre-processing logic for this first example predictive analytics pipeline may take various other forms as well.

The AI model for this first example predictive analytics pipeline may be a BERT model that is configured for text classification, which may have been trained via a pre-training phase (e.g., as described above with respect to FIG. 2). Optionally, the BERT model may also be trained via an optional fine-tuning phase as described above with respect to FIG. 2. If such the fine-tuning phase is performed, the label for each given training instance in the training data indicates the project title of a construction project (e.g., a historical project or a simulated project) in which the given textual element represented by the given training instance is found.

Inputs for the BERT model (e.g., the feature variables which the BERT model is configured to receive as input) may comprise an identified set of textual elements along with any combination of the contextual data described above for the identified set of textual elements, such as spatial information, linguistic information, and/or relational information, among other possibilities. The contextual data may, in some instances, be formatted in various ways formats and/or projected into different ranges of values (e.g., by the pre-processing logic) in order to serve as input (e.g., feature values) that will be compatible with the BERT model. The formats and value ranges may take various forms. For example, some contextual data may be transformed into a numeric format (e.g., integer, decimal, or fraction) and projected into a predetermined range of values (e.g., a range from zero to one, a range from zero to one hundred, etc.). As another example, some contextual data may be transformed into a categorical format based on predefined categories (e.g., categories for parts of speech, such as noun, verb, preposition, adjective, adverb, definite article, etc.). Other formats and value ranges are also possible.

Outputs of the BERT model may comprise a set of candidate project titles (which the BERT model predicts based on feature values that represent the identified set of textual elements) along with corresponding confidence scores for the candidate project titles (e.g., a score indicating a predicted likelihood that a candidate project title is correct).

The post-processing logic for this first example predictive analytics pipeline may include logic to identify the candidate project title having the highest confidence score (e.g., the candidate project title whose corresponding predicted likelihood is greater than the predicted likelihoods for any of the other candidate titles for the project). The post-processing logic may then output the identified candidate project title as the project title that this first example predictive analytics pipeline predicts. In addition or alternatively, the post-processing logic may compare the confidence scores of the candidate titles to a threshold confidence score and output any candidate project title whose confidence score exceeds (or at least equals) the threshold confidence score. If none of the confidence scores of the candidate titles exceeds (or at least equals) the threshold confidence score, the post-processing logic may output an indication that none of the candidate project titles has a sufficiently high confidence score.

Turning to the second example predictive analytics pipeline for predicting project title, the source data for this second example predictive analytics pipeline may include a specification for the project. In contrast with the drawings that serve as the source data for the first example predictive analytics pipeline, the specification may be primarily text-based rather than image-based. However, both the drawings and the specification may be part of the same project (i.e., the project for which a predicted project title is sought). One advantage of using different types of source data for the first example predictive analytics pipeline and the second example predictive analytics pipeline, respectively, is that each respective example predictive analytics pipeline can include a respective type of AI model that is known to achieve high prediction accuracy when trained using respective feature data based on the respective type of source data used by the respective example predictive analytic pipeline. Furthermore, different types of source data can introduce different types of bias. However, if the first example predictive analytics pipeline and the second example predictive analytics pipeline have different biases that result from their different types of source data (and from their respective AI models if the respective AI models are of different model types), the first example predictive analytics pipeline and the second example predictive analytics pipeline may be used in tandem with each other in a set of predictive analytics pipelines for predicting project title, thereby achieving greater prediction accuracy than either example predictive analytics pipeline could achieve alone.

Returning to the second example predictive analytics pipeline, the specification that serves as source data for this second example predictive analytics pipeline may be organized into a plurality of divisions in accordance with an industry standard, such as a general division (e.g., the “general requirements” division of the MasterFormat® standard, the current version of which includes fifty divisions) and a number of other divisions. The pre-processing logic for this second example predictive analytics pipeline may include logic for identifying the general division of the specification and extracting the text found therein (i.e., the general-division text). The pre-processing logic may further include logic for generating a prompt that is to be submitted to the AI model along with the general-division text. The prompt may take various forms. For example, the prompt may be a natural-language request for the AI model to predict the title of the project based on the general-division text that was extracted from the project. The prompt may also take other forms (e.g., forms that conform to a grammar that does not match any natural language).

The pre-processing logic for this second example predictive analytics pipeline may take various other forms as well.

The AI model for this second example predictive analytics pipeline may be a GPT model that is configured for question answering. Like the BERT model described above for the first example predictive analytics pipeline, the GPT model for this second example predictive analytics pipeline may be trained via a pre-training phase (e.g., as described above with respect to FIG. 2). Optionally, the GPT model may also be trained via an optional fine-tuning phase as described above with respect to FIG. 2. If such the fine-tuning phase is performed, the label for each given training instance in the training data indicates the project title of a construction project (e.g., a historical project or a simulated project) in which the given textual element represented by the given training instance is found.

As noted above, the inputs for the GPT model may comprise general-division text from a project and a prompt that requests that the GPT model predict the project's title based on the general-division text. The output of the GPT model may comprise a candidate project title identified or generated by the GPT model. Unlike the BERT model described above for the first example predictive analytics pipeline, the GPT model for this second example predictive analytics pipeline might not output a confidence score for the candidate project title. As a result, the second example predictive analytics pipeline may output the candidate project title directly without applying any post-processing logic (e.g., the second example predictive pipeline may not have to include any post-processing logic.) Alternatively, the second example predictive analytics pipeline may include some post-processing logic for handling scenarios in which the GPT model fails to output a candidate project title (e.g., if the GPT model simply outputs an error message or a message saying that there is insufficient data to make a prediction, the post-processing logic may output an indication that the attempt to predict the project title failed).

In line with the discussion above, in at least some implementations, an attribute-specific set of one or more predictive analytics pipelines for predicting project title may include both of the foregoing examples of predictive analytics pipelines. In such implementations, in operation, the attribute-specific set of one or more predictive analytics pipelines for predicting project title may function to output multiple predicted values of the project title-a first candidate project title that is output by the first example predictive analytics pipeline and a second candidate project title that is output by the second example predictive analytics pipeline. In such implementations, the back-end computing platform 102 may optionally be configured with additional logic for selecting between and/or combining the candidate project titles. In other implementations, the back-end computing platform 102 may store both candidate project titles and provide an option for a user to select one of the candidate projects manually via a user interface.

Other examples of predictive analytics pipelines for predicting project title may also be created in accordance with the present disclosure, including but not limited to predictive analytics pipelines that are based on other types of AI models.

### Project Description

Turning to project description as a second type of project attribute, an attribute-specific set of one or more predictive analytics pipelines may include at least one predictive analytics pipeline that is based on an LLM, such a first example predictive analytics pipeline for predicting project description that is based on a BERT model. This example of a predictive analytics pipeline for predicting project description will now be described in further detail.

The source data for this first example predictive analytics pipeline for predicting project description may include drawings that are associated with a given construction project for which a project description is to be predicted. The pre-processing logic for this first example predictive analytics pipeline for predicting project description may include logic to identify textual elements in the drawings by identifying any searchable text (e.g., stored in ASCII or Unicode encodings) that exists in the drawings and by applying OCR to identify any text that is depicted in image form. Once the textual elements have been identified, the pre-processing logic may include logic to, for each given textual element, extract respective contextual data for the given textual element. The respective contextual data may take many forms. As one possibility, the respective contextual data may include spatial information, linguistic information, and/or relational information (e.g., that indicates how the given textual element relates to other elements in the drawing in which the given textual element is found).

In line with the discussion above, each type of contextual data may take various forms. For example, the spatial information may include information identifying a position of the given textual element in the drawing, such as a distance between the textual element and an edge of the drawing in which the given textual element is found, coordinates of one or more pixels of the given textual element, or any other spatial information indicating the position of the given textual element in the drawing. As another example, the spatial information may include information identifying an orientation of the given textual element, such as whether the given textual element is oriented vertically, horizontally, or at some other angle of rotation. As yet another example, the spatial information may include information identifying a size of the given textual element, such as a font size or a number of pixels along one or more dimensions of the given textual element. As yet another example, the spatial information may include information identifying spacing (e.g., kerning) between characters within the given textual element. As yet another example, the spatial information may include information specifying a primary text direction (e.g., left-to-right for English, right-to-left for Hebrew or Arabic, top-to-bottom for traditional Chinese, etc.) and a secondary text direction (e.g., top to bottom for English, Hebrew, or Arabic; right-to-left for traditional Chinese; etc.). The spatial information may also take other forms.

In addition, the linguistic information may take various forms. For example, the linguistic information may include information identifying respective parts of speech (e.g., by applying a BERT model for NER to determine POS tags), conjugations (e.g., first-person singular, second-person singular, third-person plural, etc.), and tense (e.g., past or present) for the words found in the given textual element (e.g., as determined by applying existing NLP techniques). As yet another example, the linguistic information may include capitalization information (e.g., upper case or lower case) for the letters and words found in the given textual element. As still another example, the linguistic information may include information indicating a typeface (e.g., bold, italic, etc.) and a formatting style (e.g., underlining, highlighting, etc.) for the characters and words found in the textual element. The linguistic information may also take other forms.

Furthermore, the relational information may take various forms. For example, the relational information may include information about whether or not the given textual element is located inside a rectangular box or some other type of shape. As another example, the relational information may include information about which other textual elements are adjacent to the given textual element (e.g., that are within a threshold distance of the given textual element and are not separated from the given textual element by another textual element). The relational information may also take other forms.

The pre-processing logic may further logic to apply a rule-based approach to transform the textual elements into one or more ordered lists of sentences. The rule-based approach may take various forms. For instance, the rule-based approach may involve grouping the textual elements into clusters, combining the textual elements to form lines of text, and combining and/or dividing the lines of text to form sentences. In one example, the rule-based approach may involve the following. First, the pre-processing logic may include logic to define one or more clusters of textual elements found in a drawing that is included in the project for which a project description is to be predicted. The pre-processing logic may include logic to commence by selecting a first textual element (e.g., at random or arbitrarily) and adding the first textual element to a first cluster. Next, the pre-processing logic may include logic to add any neighbor textual elements of the first textual element (i.e., textual elements that are adjacent to the first textual element on any side) that have the same orientation (e.g., vertical, horizontal, or some other angle of rotation) as the first textual element to the first cluster. For each given neighbor textual element that was added to the first cluster, the pre-processing logic may include logic to repeat the process by adding any respective neighbor textual elements of the given neighbor textual element that are not already in the first cluster and have the same orientation as the given neighbor textual element to the first cluster. The pre-processing logic may include logic to repeat this process for each textual element that is added to the cluster until no textual element in the first cluster is adjacent to any textual element of the same orientation that is not included in the first cluster. If there are any remaining textual elements that are not in the first cluster, the pre-processing logic may include logic to select one of the remaining textual elements (e.g., at random or arbitrarily), add it to a second cluster, and apply the same process used for defining the first cluster to define the second cluster. The pre-processing logic may include logic to define additional clusters similarly until there are no remaining textual elements that are not included in one of the clusters.

Once the clusters have been defined, for each given cluster, the pre-processing logic may include logic to derive an ordered list of lines of text in each cluster. The pre-processing logic may include logic to commence by identifying a first textual element in a given cluster that is in a first position relative to the textual elements in the given cluster. The first position is based on the primary text direction (e.g., left to right for English), the secondary text direction (e.g., top to bottom for English), and the orientation of the textual elements in the given cluster. For example, if the primary text direction is left-to-right and the secondary text direction is top-to-bottom for textual elements in the given cluster (e.g., as would be the case if the textual elements are written in English) and the textual elements in the given cluster are oriented horizontally, the first textual element may be identified by (i) identifying a subset of textual elements in the given cluster that are positioned above any other textual elements in the given cluster except each other and (ii) selecting the leftmost textual element in the subset as the first textual element. Next, the pre-processing logic may include logic to generate a first line of text that begins with the first textual element. For example, if the first line of text is to be implemented as an instance of a string data type (e.g., a sequence of characters in a programming language such as C++, Perl, Python, C#, etc.), the first line of text may be instantiated as the empty string (i.e., a string that has zero characters) and the first textual element may be concatenated to the first line of text. Next, if there is a second textual element that is adjacent to the right side of the first textual element, the second textual element is concatenated to the first line of text. If there is a third textual element that is adjacent to the right side of the second textual element, the third textual element is also concatenated to the first line of text. This pattern is continued with each additional element that is concatenated to the line of text until there is no additional textual element that is adjacent to the right side of the last textual element that was concatenated to the first line. At this point, the first line is treated as complete and is added to the ordered list of lines of text for the given cluster. Next, the pre-processing logic may include logic to perform another iteration of the process described above for identifying the first textual element to identify an updated first textual element, but to exclude the textual elements that were included in the first line of text from this iteration of the process. Next, the pre-processing logic may include logic to generate a second line of text that begins with the updated first line of text, follow the process described above for completing the second line of text, and add the completed second line of text to the ordered list of lines of text for the given cluster. Subsequent lines of text are generated, completed, and added to the ordered list of lines of text for the given cluster until there are no more textual elements in the given cluster that have not been added to a line of text in the ordered list. Ordered lists of lines of text are created in this same manner for any other clusters that have been defined.

Once a respective ordered list of lines of text has been derived for each of the clusters, the pre-processing logic may direct the back-end computing platform 102 to derive a respective ordered list of sentences for each of the clusters. For example, beginning at the left side (or, if the primary text direction is right-to-left, the right side) of first line in the ordered list of lines of text for a given cluster, the pre-processing logic may include logic to scan from left to right (or from right to left if the primary text direction is right-to-left) until a combination of one or more characters that matches a predefined end-of-sentence pattern is detected. The predefined end-of-sentence pattern may be, for example, that a sentence-ending punctuation character (e.g., a period, a question mark, or an exclamation point in English) is present and that none of one or more predefined exceptions apply (e.g., a predefined exception may be that a period is immediately preceded by an abbreviation that includes more than one upper-case letter). Once a match for a predefined end-of-sentence pattern is detected, the back-end computing platform 102 generates a first sentence (e.g., implemented as an instance of a string data type) that includes (i) the sequence of characters in the line of text that precede a sentence-ending punctuation character found in the combination of one or more characters that matches the end-of-sentence pattern and (ii) any characters that precede the first whitespace character that follows the sentence-ending punctuation character in the line of text (e.g., such as closing quotation marks that immediately follow a period). The back-end computing platform 102 adds the first sentence to the ordered list of sentences for the given cluster. Next, the back-end computing platform 102 resumes scanning the first line from right to left until a second combination of one or more characters that matches a predefined end-of-sentence pattern is detected. Next, the back-end computing platform 102 generates a second sentence that includes (i) the sequence of characters in the line of text that were not included in first sentence and that precede a second sentence-ending punctuation character found in the second combination; and (ii) any characters that precede the first whitespace character that follows the second sentence-ending punctuation character in the line of text. The back-end computing platform 102 then adds the second sentence to the ordered list of sentences for the given cluster. Any other complete sentences in the first line are similarly generated and added to the list until the end of the first line is reached. Any characters that are positioned between the end of the last complete sentence derived from the first line and the end of the first line are stored in a remainder string for the first line. Next, the back-end computing platform 102 moves to the next line of text (e.g., the second line of text) in the ordered list of lines of text for the given cluster and applies the process that was applied to the first line of text to the next line of text with one addendum action-namely, the remainder string for the preceding line (e.g., the first line) is appended to the front of the first sentence derived from this next line of text. This process (including the addendum action) is repeated for each line of text in the ordered list of lines of text for the given cluster. The respective ordered lists of sentences for any other clusters are determined in a similar manner.

The rule-based approach for transforming the textual elements into one or more ordered lists of sentences may also take other forms. Furthermore, the pre-processing logic for this first example predictive analytics pipeline may take various other forms as well.

The AI model for this first example predictive analytics pipeline for predicting project description may be a BERT model that is configured for textual similarity. The BERT model may be trained via a pre-training phase (e.g., as described above with respect to FIG. 2). Optionally, the BERT model may also be trained via an optional fine-tuning phase as described above with respect to FIG. 2. If such the fine-tuning phase is performed, the training data may comprise a collection of training instances. Each given training instance may comprise (i) an ordered list of sentences found in a given drawing included in a given historical and/or simulated project and (ii) a label that indicates whether the ordered list of sentences is the project description of the given project. During the fine-tuning phase of training, the BERT model (i) receives each given training instance as input, (ii) converts the ordered list of sentences found in the given training instance to tokens via a BERT tokenizer (e.g., such as an instance of the “BertTokenizer class” found in the Hugging Face® “transformers” library), (iii) converts the tokens to a vector of corresponding BERT embeddings (iv) predicts whether the ordered list of sentences is the project description of the given project, (v) compares the prediction to the label of the given training instance, and (vi) adjusts model parameters (e.g., the weights and biases found in different layers of the BERT model) within the BERT model based on any difference that exists between the prediction and the label.

Inputs for the BERT model (e.g., the feature variables which the BERT model is configured to receive as input) may comprise the ordered list of sentences found in a given drawing. If the BERT model is trained and operates in the manner described above, an ordered list of sentences itself may constitute sufficient input for the BERT model to predict whether the ordered list of sentences is a project description. However, the inputs for the BERT model may also include other data, such as any combination of the types of contextual data mentioned above for the textual elements that were used to create the ordered list of sentences. Furthermore, the ordered list of sentences may be stored in many different types of data structures (e.g., in an array of strings, in a single string, etc.). Other types and combinations of inputs are also possible.

In this example, upon receiving the inputs, the BERT model may commence by transforming the inputs (e.g., including the ordered list of sentences) into a target vector of numeric values that represent the inputs. Next, the BERT model may compare the target vector to one or more ground-truth vectors that were similarly transformed (e.g., by the BERT model) from respective inputs that have been verified to be project descriptions (e.g., found in respective historical projects). The comparison may involve, for example, computing a respective cosine similarity score between each of the one or more ground-truth vectors and the target vector. Once the respective cosine similarity scores have been computed, there are several different approaches that the BERT model may apply to determine whether the ordered list of sentences represented by the target vector is a project description. As one possibility, the BERT model may compute an average cosine similarity score based on the respective cosine similarity scores and compare the average cosine similarity score to an average-score threshold. If the average cosine similarity score equals or exceeds the average-threshold score, the BERT model may predict that the ordered list of sentences is a project description. Conversely, if the average cosine similarity score is less than the average-threshold score, the BERT model may predict that the ordered list of sentences is not a project description. As another possibility, the BERT model may compare each respective cosine similarity score to a threshold score and tabulate a count of the number of respective cosine similarity scores that equal or exceed the threshold score. If the count equals or exceeds the threshold count, the BERT model may predict that the ordered list of sentences is a project description. Conversely, if the count is less than the threshold count, the BERT model may predict that the ordered list of sentences is not a project description. Other approaches are also possible. Outputs of the BERT model may include a set of candidate project descriptions (which may, for example, be the ordered list of sentences) along with corresponding confidence scores for the candidate project descriptions (e.g., a score indicating a predicted likelihood that a candidate project description is correct.

The post-processing logic for this first example predictive analytics pipeline for predicting project description may include logic to identify the candidate project description having the highest confidence score (e.g., the candidate project description whose corresponding predicted likelihood is greater than the predicted likelihoods for any of the other candidate project descriptions for the given project. Furthermore, the post-processing logic may include logic to add additional text to the candidate project description. For example, text that is found in the drawing that includes the candidate project description and is located within a threshold distance of the candidate project description may be added to the project description.

The post-processing logic may further include logic to output the identified candidate project description as the predicted project description. In addition or alternatively, the post-processing logic may further include logic to compare the confidence scores of the candidate project descriptions to a threshold confidence score and output any candidate project description whose confidence score exceeds (or at least equals) the threshold confidence score. If none of the confidence scores of the candidate descriptions exceeds (or at least equals) the threshold confidence score, the post-processing logic may further include logic to output an indication that none of the candidate project descriptions in the set has a sufficiently high confidence score.

Other examples of predictive analytics pipelines for predicting project description may also be created in accordance with the present disclosure, including but not limited to predictive analytics pipelines that are based on other types of AI models.

### Project Address

Turning to project address (e.g., a street address for a structure to which a project pertains) as a third type of project attribute, an attribute-specific set of one or more predictive analytics pipelines for predicting project address may include at least one predictive analytics pipeline that is based on a type of LLM, such as a first example predictive analytics pipeline for predicting project title that is based on a BERT model and/or a second example predictive analytics pipeline for predicting project address that is based on a GPT model that is configured for question answering. These examples of predictive analytics pipelines for predicting project address will now be described in further detail.

The source data for this first example predictive analytics pipeline for predicting project address may include drawings that are associated with a given construction project for which a project address is to be predicted. The pre-processing logic for this first example predictive analytics pipeline for predicting project address may include logic to identify textual elements in the drawing by identifying any searchable text (e.g., stored in ASCII or Unicode encodings) that exists in the drawing and by applying OCR to identify any text that is depicted in image form. Once the textual elements have been identified, the pre-processing logic may include logic to identify a subset of textual elements that are likely to be addresses. For example, the pre-processing logic may include logic to apply a pre-trained BERT NER model that has been trained to identify locations (e.g., such as an instance of the bert-base-NER model that is available through the Hugging Face® platform) to the textual elements. Any of the textual elements whose likelihood (e.g., as predicted by the BERT NER) of representing a place satisfies a predefined threshold condition is included in the subset. In addition or alternatively, the pre-processing logic may include logic to apply an address detection function (e.g., such as the address detection functions provided by the Python address parser (PYAP) library that is available through GitHub®) to the textual elements. Any textual elements that include potential addresses are included in the subset.

The pre-processing logic may further include logic to, for each given textual element in the subset, extract respective contextual data for the given textual element. The respective contextual data may take many forms. As one possibility, the respective contextual data may include spatial information, linguistic information, and/or relational information. In line with the discussion above, each type of contextual data may take various forms, such as the forms described above with respect to the example pipelines for predicting project title. As one example, the relational data may include information about whether any other textual elements are nearby (e.g., within a threshold distance of) the given textual element and/or whether these nearby textual elements include any words found in a predefined positive-correlation list (e.g., words that are typically found near project addresses), such as “address” or “zip.” As another example, the linguistic information may include information identifying whether the given textual element includes any predefined stop words (e.g., words that are not typically found in project addresses), such as “page” or “schematic,” and/or how many of these stop words are included in the given textual element.

The pre-processing logic for this first example predictive analytics pipeline may take various other forms as well.

The AI model for this first example predictive analytics pipeline for predicting project address may be a BERT model that is configured for text classification. The BERT model may be trained via a pre-training phase (e.g., as described above with respect to FIG. 2). Optionally, the BERT model may also be trained via an optional fine-tuning phase as described above with respect to FIG. 2. If such the fine-tuning phase is performed, the label for each given training instance in the training data indicates the project address of a construction project (e.g., a historical project or a simulated project) in which the given textual element represented by the given training instance is found.

Inputs for the BERT model (e.g., the feature variables which the BERT model is configured to receive as input) may comprise an identified set of textual elements along with any combination of the contextual data described above for the identified set of textual elements, such as spatial information, linguistic information, and/or relational information, among other possibilities. The contextual data may, in some instances, be formatted in various ways formats and/or projected into different ranges of values (e.g., by the pre-processing logic) in order to serve as input (e.g., feature values) that will be compatible with the BERT model. The formats and value ranges may take various forms. For example, some contextual data may be transformed into a numeric format (e.g., integer, decimal, or fraction) and projected into a predetermined range of values (e.g., a range from zero to one, a range from zero to one hundred, etc.). As another example, some contextual data may be transformed into a categorical format based on predefined categories (e.g., categories for parts of speech, such as noun, verb, preposition, adjective, adverb, definite article, etc.). Other formats and value ranges are also possible.

Outputs of the BERT model may include a set of candidate project addresses along with corresponding confidence scores for the candidate project addresses (e.g., a score indicating a predicted likelihood that a candidate project address is correct).

The post-processing logic for this first example predictive analytics pipeline for predicting project address may include logic to identify the candidate project address whose corresponding predicted likelihood is greater than the predicted likelihoods for any of the other candidate project addresses for the given project.

The post-processing logic may further include logic to identify the candidate project address having the highest confidence score as the predicted project address. In addition or alternatively, the post-processing logic may further include logic to compare the confidence scores of the candidate project addresses to a threshold confidence score and output any candidate project address whose confidence score exceeds (or at least equals) the threshold confidence score. If none of the confidence scores of the candidate addresses exceeds (or at least equals) the threshold confidence score, the post-processing logic may further include logic to output an indication that none of the candidate project addresses has a sufficiently high confidence score.

Turning to the second example predictive analytics pipeline for predicting project address, the source data for this second example predictive analytics pipeline may include a specification for the project. In contrast with the drawings that serve as the source data for the first example predictive analytics pipeline for predicting project address, the specification may be primarily text-based rather than image-based. However, both the drawings and the specification may be part of the same project (i.e., the project for which a project address is to be predicted).

Returning to the second example predictive analytics pipeline for predicting project address, the specification that serves as source data for this second example predictive analytics pipeline may be organized into a plurality of divisions in accordance with an industry standard, such as a general division (e.g., the “general requirements” division of the MasterFormat® standard) and a number of other divisions. The pre-processing logic for this second example predictive analytics pipeline for predicting project address may include logic for identifying the general division of the specification and extracting the text found therein (i.e., the general-division text). The pre-processing logic may further include logic for generating a prompt that is to be submitted to the AI model for this second example predictive analytics pipeline along with the general-division text. The prompt may take various forms. For example, the prompt may be a natural-language request for the AI model to predict the project address of the project based on the general-division text that was extracted from the project. The prompt may also take other forms (e.g., forms that conform to a grammar that does not match any natural language).

The pre-processing logic for this second example predictive analytics pipeline may take various other forms as well.

The AI model for this second example predictive analytics pipeline for predicting project address may be a GPT model that is configured for question answering. Like the BERT model described above for the first example predictive analytics pipeline for predicting project address, the GPT model for this second example predictive analytics pipeline may be trained via a pre-training phase (e.g., as described above with respect to FIG. 2). Optionally, the GPT model may also be trained via an optional fine-tuning phase as described above with respect to FIG. 2. If such the fine-tuning phase is performed, the label for each given training instance in the training data indicates the project address of a construction project (e.g., a historical project or a simulated project) that corresponds to the given training instances.

As noted above, the inputs for the GPT model may comprise general-division text from a project and a prompt that requests that the GPT model predict the project's address based on the general-division text. The output of the GPT model may comprise a candidate project address identified or generated by the GPT model. Unlike the BERT model described above for the first example predictive analytics pipeline for predicting project address, the GPT model for this second example predictive analytics pipeline might not output a confidence score for the candidate project address. As a result, the second example predictive analytics pipeline for predicting project address may output the candidate project address directly without applying any post-processing logic (e.g., the second example predictive pipeline may not have to include any post-processing logic.) Alternatively, the second example predictive analytics pipeline for predicting project address may include some post-processing logic for handling scenarios in which the GPT model fails to output a candidate project address (e.g., if the GPT model simply outputs an error message or a message saying that there is insufficient data to make a prediction, the post-processing logic may output an indication that the attempt to predict the project address failed).

In line with the discussion above, in at least some implementations, an attribute-specific set of one or more predictive analytics pipelines for predicting project address may include both of the foregoing examples of predictive analytics pipelines for predicting project address. In such implementations, in operation, the attribute-specific set of one or more predictive analytics pipelines for predicting project address may function to output multiple predicted values of the project address-a first candidate project address that is output by the first example predictive analytics pipeline for predicting project address and a second candidate project address that is output by the second example predictive analytics pipeline for predicting project address. In such implementations, the back-end computing platform 102 may optionally be configured with additional logic for selecting between and/or combining the candidate project addresses. In other implementations, the back-end computing platform 102 may store both candidate project addresses and provide an option for a user to select one of the candidate project addresses manually via a user interface.

Other examples of predictive analytics pipelines for predicting project address may also be created in accordance with the present disclosure, including but not limited to predictive analytics pipelines that are based on other types of AI models.

### Project Area (and Units Used to Measure Project Area)

Turning to project area (e.g., the gross area of a structure to which a project pertains as measured in some unit of distance squared) as a fourth type of project attribute, an attribute-specific set of one or more predictive analytics pipelines for predicting project area may include at least one predictive analytics pipeline that is based on a decision-tree model, such as a first example predictive analytics pipeline for predicting project area that is based on a gradient-boosted decision tree (GBDT) model (e.g., an XGBoost model that may be implemented via the XGBoost library that is available through GitHub®) and/or a second example predictive analytics pipeline for predicting project area that is based on a computer-vision model. These examples of predictive analytics pipelines for predicting project area will now be described in further detail.

The source data for this first example predictive analytics pipeline for predicting project area may include drawings that are associated with a given construction project for which area is to be predicted. The pre-processing logic for this first example predictive analytics pipeline for predicting project area may include logic to identify textual elements in the drawings by identifying any searchable text (e.g., stored in ASCII or Unicode encodings) that exists in the drawing and by applying OCR to identify any text that is depicted in image form. Once the textual elements have been identified, the pre-processing logic may include logic to identify textual elements that are likely to indicate areas. Specifically, the pre-processing logic may include logic to identify textual elements that match a predefined pattern associated with areas. The predefined pattern may take any of various forms. As one example, the pre-processing logic may specify that the predefined pattern is that (i) a number (e.g., expressed in a digit form such as “1,” “2,” etc. or expressed in a word form such as “one,” “two,” etc.) is present, (ii) a token that indicates a unit of distance measurement (e.g., a predefined list of tokens such as “square feet,” “feet squared,” “square footage,” “sq ft,” “sf,” “ft2,” “square meters,” “meters squared,” “square metres,” “sq m,” “m²,” etc.) is present, and (iii) the number and the token are not separated from each other by non-whitespace characters nor by more than a threshold distance (e.g., measured in pixels or characters) in the drawing in which the number and the token are found. The predefined pattern may also take other forms. The pre-processing logic may include logic to exclude any textual elements that do not match the predefined pattern from further consideration as potential areas.

The pre-processing logic may further include logic to, for each given textual element that was not excluded, extract respective contextual data for the given textual element from the respective drawing in which the given textual element is found. The respective contextual data may take many forms. As one possibility, the respective contextual data may include spatial information, linguistic information, and/or relational information. In line with the discussion above, each type of contextual data may take various forms, such as the forms described above with respect to the example pipelines for predicting project title. As one example, the relational data may include information about whether any other textual elements are nearby (e.g., within a threshold distance of) the given textual element and/or whether these nearby textual elements include any words found in a predefined positive-correlation list (e.g., words that are frequently found near project areas in drawing), such as “area” or “space,” and how many of these positive-correlation words are nearby. As another example, the linguistic information may include information identifying whether the given textual element includes any predefined stop words (e.g., words that are not typically found near project areas in drawings), such as “title” or “HVAC,” and/or how many of these stop words are included in the given textual element.

The AI model for this first example predictive analytics pipeline for predicting project area may be an XGBoost model (e.g., for text classification). The XGBoost model may be trained (e.g., by the back-end computing platform 102) in the manner described above with respect to FIG. 2. The label for each given training instance in the training data for the XGBoost model indicates the project area of a construction project (e.g., a historical project or a simulated project) corresponding to the given training instance.

Inputs for the XGBoost model (e.g., the feature variables which the XGBoost model is configured to receive as input) may comprise any combination of the contextual data described above for textual elements, such as spatial information, linguistic information, and/or relational information, among other possibilities. The contextual data may, in some instances, be formatted in various ways formats and/or projected into different ranges of values (e.g., by the pre-processing logic) in order to serve as input (e.g., feature values) that will be compatible with the XGBoost model. The formats and value ranges may take various forms. For example, some contextual data may be transformed into a numeric format (e.g., integer, decimal, or fraction) and projected into a predetermined range of values (e.g., a range from zero to one, a range from zero to one hundred, etc.). As another example, some contextual data may be transformed into a categorical format based on predefined categories (e.g., categories for parts of speech, such as noun, verb, preposition, adjective, adverb, definite article, etc.). Other formats and value ranges are also possible.

Outputs of the XGBoost model may include (i) a candidate project area (which may, for example, be the given textual element or a portion thereof) and (ii) a predicted likelihood that the candidate project area is the true project area for the given project in which the drawing that contains the candidate project area is found.

The post-processing logic for this first example predictive analytics pipeline for predicting project area may include logic to identify the candidate project area whose corresponding predicted likelihood is greater than the predicted likelihoods for any of the other candidate project area for the given project.

The post-processing logic may further include logic to output the identified candidate project area as the predicted project area. In addition or alternatively, the post-processing logic may further include logic to compare the predicted likelihoods of the candidate project areas to a threshold likelihood and output any candidate project areas whose predicted likelihood exceeds (or at least equals) the threshold likelihood. If none of the predicted likelihoods of the candidate project areas exceeds (or at least equals) the threshold likelihood, the post-processing logic may further include logic to output an indication that none of the candidate project area has a sufficiently high predicted likelihood.

Turning to the second example predictive analytics pipeline for predicting project area, the source data for this second example predictive analytics pipeline may include a plurality of drawings-specifically, drawings that are floor plans.

The pre-processing logic may include logic to select a set of drawings that are floor plans from a larger set of drawings for a project. The larger set of drawings may include drawings of many different types. The pre-processing logic may include logic to identify drawings that are floor plans based on metadata in the drawings themselves (e.g., metadata that explicitly specifies the drawings are floor plans). For drawings that lack such metadata, the pre-processing logic may include logic to perform OCR and search the OCR text for one or more tokens that are strongly correlated with floor plans (e.g., such as the token “floor plan”). Based on the tokens identified, the pre-processing logic may include logic to include drawings that have many strongly correlated tokens in the set of drawings (and to exclude drawings that lack strongly correlated tokens or that have many tokens that are more strongly correlated with other types of drawings).

In addition, the pre-processing logic may include logic to determine one or more scales for the drawings in the set of drawings. For example, the pre-processing logic may include logic to identify a respective scale for a given drawing in the set based on metadata included in the given drawing (e.g., metadata that explicitly specifies the scale). For drawings that lack such metadata, the pre-processing logic may include logic to perform OCR and search the OCR text for one or more patterns that are likely to represent scale (e.g., a first number followed by a colon that is followed by a second number that is larger than the first number, a first number followed by a unit of length followed by an equals sign followed by a second number followed by a second unit of length, or some other pattern indicating a scale).

The AI model for this second example predictive analytics pipeline for predicting project area may include a computer-vision model (e.g., a hierarchical vision transformer classification model). The training data for the computer-vision model may comprise a plurality of training instances. Each given training instance may represent a respective project and may include (i) a plurality of drawings that are floor plans included in the respective project and (ii) a label that indicates a location hierarchy for spaces depicted in the plurality of drawings.

The training data may be derived from historical projects and/or simulated projects whose location hierarchies are known (e.g., verified and treated as ground-truth data). The training data includes a plurality of training instances whose labels indicate respective location hierarchies for the historical projects and/or simulated projects.

During training, the computer-vision model will (i) receive each given training instance as input, (ii) predict a location hierarchy for the respective project based on the plurality of drawings found in the given training instance, (iii) compare the predicted location hierarchy to the label found in the given training instance, and (iv) adjust model parameters (e.g., the weights and biases found in different layers of the computer-vision model) within the computer-vision model based on any difference that exists between the predicted location hierarchy and the location hierarchy indicated by the label.

As noted above, the inputs for the computer-vision model may comprise a plurality of drawings that are floor plans. The output of the computer-vision model may comprise a predicted location hierarchy for the given project that corresponds to the inputs.

The post-processing logic for this second example predictive analytics pipeline for predicting project area may include logic to calculate a respective area for each respective floor depicted in a respective one of the drawings by (i) identifying non-overlapping spaces that are contained within the respective floor based on the predicted location hierarchy, (ii) calculating a respective area for each identified non-overlapping space contained within the respective floor, (iii) summing the respective areas for the identified non-overlapping spaces contained within the respective floor, and (iv) applying a respective scale for the floor to the sum. The post-processing logic may further include logic to determine the project area by summing the respective areas for the respective floors.

In line with the discussion above, in at least some implementations, an attribute-specific set of one or more predictive analytics pipelines for predicting project area may include both of the foregoing examples of predictive analytics pipelines for predicting project area. In such implementations, in operation, the attribute-specific set of one or more predictive analytics pipelines for predicting project area may function to output multiple predicted values of the project area-a first candidate project area that is output by the first example predictive analytics pipeline for predicting project area and a second candidate project area that is output by the second example predictive analytics pipeline for predicting project area. In such implementations, the back-end computing platform 102 may optionally be configured with additional logic for selecting between and/or combining the candidate project areas. In other implementations, the back-end computing platform 102 may store both candidate project areas and provide an option for a user to select one of the candidate project areas manually via a user interface.

Other examples of predictive analytics pipelines for predicting project area may also be created in accordance with the present disclosure, including but not limited to predictive analytics pipelines that are based on other areas of AI models.

### Project Type

Turning to project type (e.g., a project's type as defined according to an industry standard such as the OmniClass® classification system) as a fifth type of project attribute, an attribute-specific set of one or more predictive analytics pipelines for predicting project type may include at least one predictive analytics pipeline for predicting project type that is based on a rule-based model (e.g., a trained association-rule model, a set of user-defined rules, or a hybrid model) and/or a second example predictive analytics pipeline for predicting project type that is based on an LLM (e.g., a GPT model). These examples of predictive analytics pipelines for predicting project type will now be described in further detail.

The source data for the first example predictive analytics pipeline for predicting project type may include a plurality of attribute values for the project, such as a value for the project title and a value for the project description. The value for the project title and/or the value for the project description may be known (e.g., manually specified by a user beforehand via a user interface) or may be values that were predicted beforehand by attribute-specific sets of predictive analytic pipelines for predicting project title and project description (e.g., such as those described in the examples above for project title and project description). Thus, the outputs of other sets of attribute-specific analytics pipelines may serve as inputs for other sets of attribute-specific analytics pipelines, resulting in an advantageous synergistic effect in which the predictions of some attributes may leverage previously determined predictions of other attributes. In addition, the source data may also include an alternate project type value that has been previously provided (e.g., by a user via an interface), but does not conform to a classification system for which a project type prediction is desired.

The pre-processing logic for this first example predictive analytics pipeline for predicting project type may include logic to retrieve the plurality of attribute values from memory or storage (e.g., via construction management software in which the project is instantiated). The pre-processing logic may also include logic for transforming the plurality of attribute values into a format that is compatible with the rule-based model. The formats and value ranges may take various forms. For example, some attribute values may be transformed into a numeric format (e.g., integer, decimal, or fraction) and projected into a predetermined range of values (e.g., a range from zero to one, a range from zero to one hundred, etc.). As another example, some attribute values may be transformed into a categorical format based on predefined categories. Other formats and value ranges are also possible. Furthermore, the pre-processing logic may include logic to generate a query in a query syntax that the AI model is configured to parse. The query may instruct the AI model to return a prediction for project type based on the plurality of attribute values.

The AI model for this first example predictive analytics pipeline for predicting project type may be a rule-based model. The rule-based model may take various forms and may be generated in different ways (e.g., as described above with respect to FIG. 2). If the rule-based model comprises an association-rule model, The training data for the association-rule model may comprise a collection of training instances. Each given training instance may represent a corresponding historical and/or simulated project. Furthermore, each given training instance may comprise (i) the attribute values (e.g., which are actual parameters) that map to respective feature variables (e.g., formal parameters that indicate the attribute types, such as project title, project description, and alternate project type) for the association-rule model and (ii) a label that indicates the project type of the project represented by the training instance, the training may involve applying an association-rule training technique such as Apriori, FP-Growth, Eclat, or some other technique that detects non-independence between attribute values and project types and leverages that non-independence to create rules for predicting project type based on attribute value.

Inputs for the rule-based model may include the plurality of attribute values from the project and, if applicable, a query that instructs the AI model to return a prediction for project type based on the plurality of attribute values.

Outputs of the rule-based model may include a predicted project type. In addition, the AI model may also output additional information, such as one or more specific rules that were applied to determine the predicted project type. Also, in examples where an association-rule model is used, the output may include one or more respective confidence levels for the one or more respective rules that were applied. For example, the confidence level for a rule may be determined by (i) identifying a number of training instances in the training data to which the rule applies and (ii) calculating the percentage of those training instances for which the rule accurately predicts the project type indicated by their respective labels.

The post-processing logic for this first example predictive analytics pipeline for predicting project type may include logic to compare respective confidence levels for the one or more rules that were applied to respective threshold confidence levels. If the one or more confidence levels match or exceed their respective threshold confidence levels, the post-processing logic may dictate that the first example predictive analytics pipeline for predicting project type outputs the predicted project type as a candidate project type. Otherwise, the post-processing logic may include logic for sending a message indicating that one or more threshold conditions were not satisfied.

Turning to the second example predictive analytics pipeline for predicting project type, the source data for this second example predictive analytics pipeline may include a plurality of attribute values for the project, such as a value for the project title and a value for the project description. The value for the project title and/or the value for the project description may be known (e.g., manually specified by a user beforehand via a user interface) or may be values that were predicted beforehand by attribute-specific sets of predictive analytic pipelines for predicting project title and project description (e.g., such as those described in the examples above for project title and project description). In addition, the source data may also include an alternate project type value that has been previously provided (e.g., by a user via an interface), but does not conform to a classification system for which a project type prediction is desired.

The pre-processing logic for this second example predictive analytics pipeline for predicting project type may include logic for generating a prompt that is to be submitted to the AI model for this second example predictive analytics pipeline along with the plurality of attribute values. The prompt may take various forms. For example, the prompt may be a natural-language request for the AI model to predict the project type of the project based on the plurality of attribute values. The prompt may also take other forms (e.g., forms that conform to a grammar that does not match any natural language).

The AI model for this second example predictive analytics pipeline for predicting project type may be a GPT model that is configured for question answering. The GPT model for this second example predictive analytics pipeline may be trained via a pre-training phase (e.g., as described above with respect to FIG. 2). Optionally, the GPT model may also be trained via an optional fine-tuning phase as described above with respect to FIG. 2. If such the fine-tuning phase is performed, the label for each given training instance in the training data indicates the project type of a construction project (e.g., a historical project or a simulated project) that corresponds to the given training instance.

As noted above, the inputs for the GPT model may comprise a plurality of attribute values from a project and a prompt that requests that the GPT model predict the project's type based on the plurality of attribute values. The output of the GPT model may comprise a candidate project type identified or generated by the GPT model. The GPT model for this second example predictive analytics pipeline might not output a confidence score for the candidate project type. As a result, the second example predictive analytics pipeline for predicting project type may output the candidate project type directly without applying any post-processing logic (e.g., the second example predictive pipeline may not have to include any post-processing logic.) Alternatively, the second example predictive analytics pipeline for predicting project type may include some post-processing logic for handling scenarios in which the GPT model fails to output a candidate project type (e.g., if the GPT model simply outputs an error message or a message saying that there is insufficient data to make a prediction, the post-processing logic may output an indication that the attempt to predict the project type failed).

In line with the discussion above, in at least some implementations, an attribute-specific set of one or more predictive analytics pipelines for predicting project type may include both of the foregoing examples of predictive analytics pipelines for predicting project type. In such implementations, in operation, the attribute-specific set of one or more predictive analytics pipelines for predicting project type may function to output multiple predicted values of the project type-a first candidate project type that is output by the first example predictive analytics pipeline for predicting project type and a second candidate project type that is output by the second example predictive analytics pipeline for predicting project type. In such implementations, the back-end computing platform 102 may optionally be configured with additional logic for selecting between and/or combining the candidate project types. For example, if the candidate project type output by the rule-based model is associated with a confidence level that falls below a threshold confidence level, the additional logic may select the candidate project type output by the GPT model. In other implementations, the back-end computing platform 102 may store both candidate project types and provide an option for a user to select one of the candidate project types manually via a user interface.

Other examples of predictive analytics pipelines for predicting project type may also be created in accordance with the present disclosure, including but not limited to predictive analytics pipelines that are based on other types of AI models.

### Occupancy Code

Turning to occupancy code (e.g., a project's occupancy code as defined by an industry standard such as the International Building Code (IBC) provided by the International Code Council (ICC)) as a sixth type of project attribute, an attribute-specific set of one or more predictive analytics pipelines for predicting occupancy code may include at least one predictive analytics pipeline that is based on a decision-tree model, such as a first example predictive analytics pipeline for predicting occupancy code that is based on a GBDT model (e.g., an XGBoost model that may be implemented via the XGBoost library that is available through GitHub®) and/or a second example predictive analytics pipeline for predicting occupancy code that is based on a rule-based model (e.g., a trained association-rule model or a set of user-defined rules). These examples of predictive analytics pipelines for predicting occupancy code will now be described in further detail.

The source data for this first example predictive analytics pipeline for predicting occupancy code may include drawings that are associated with a given construction project for which occupancy code is to be predicted. The pre-processing logic for this first example predictive analytics pipeline for predicting occupancy code may include logic to identify textual elements in the drawings by identifying any searchable text (e.g., stored in ASCII or Unicode encodings) that exists in the drawing and by applying OCR to identify any text that is depicted in image form. Once the textual elements have been identified, the pre-processing logic may include logic to identify textual elements that are likely to be occupancy codes. Specifically, the pre-processing logic may include logic to identify textual elements that match a predefined pattern associated with occupancy codes. The predefined pattern may take any of various forms. As one example, the pre-processing logic may specify that the predefined pattern is that (i) an upper-case letter is present; (ii) at least one whitespace character immediately precedes the upper-case letter; (iii) either a whitespace character or a dash (e.g., a hyphen, an en dash, or an em dash) immediately follows the upper-case letter, (iv) if a dash immediately follows the upper-case letter, the dash is immediately followed by a digit; (v) a token that is correlated with occupancy code (e.g., a predefined list of tokens such as “occupancy,” “OCC,” OC,” of “Code”) is present, and (iii) the upper-case letter and the token are not separated from each other by more than a threshold distance (e.g., measured in pixels or characters) in the drawing in which the upper-case letter and the token are found. The predefined pattern may also take other forms. The pre-processing logic may include logic to exclude any textual elements that do not match the predefined pattern from further consideration as occupancy codes.

The pre-processing logic may further include logic to, for each given textual element that was not excluded, extract respective contextual data for the given textual element from the respective drawing in which the given textual element is found. The respective contextual data may take many forms. As one possibility, the respective contextual data may include spatial information, linguistic information, and/or relational information. In line with the discussion above, each type of contextual data may take various forms, such as the forms described above with respect to the example pipelines for predicting project title. As one example, the relational data may include information about whether any other textual elements are nearby (e.g., within a threshold distance of) the given textual element and/or whether these nearby textual elements include any words found in a predefined positive-correlation list (e.g., words that are frequently found near occupancy code in drawings), such as “code,” and how many of these positive-correlation words are nearby. As another example, the linguistic information may include information identifying whether the given textual element includes any predefined stop words (e.g., words that are not typically found near occupancy codes in drawings) and/or how many of these stop words are included in the given textual element.

The AI model for this first example predictive analytics pipeline for predicting occupancy code may be an XGBoost model (e.g., for text classification). The training data for the XGBoost model may comprise a collection of training instances. Each given training instance may comprise (i) feature values (e.g., actual parameters) that map to respective feature variables (e.g., formal parameters) which the XGBoost model is configured to receive as input and (ii) a label that indicates whether the given textual element represented by the given training instance is an occupancy code. The back-end computing platform 102 trains the XGBoost model in the manner described above with respect to FIG. 2.

Inputs for the XGBoost model (e.g., the feature variables which the XGBoost model is configured to receive as input) may comprise any combination of the contextual data described above for textual elements, such as spatial information, linguistic information, and/or relational information, among other possibilities. The contextual data may, in some instances, be formatted in various ways formats and/or projected into different ranges of values (e.g., by the pre-processing logic) in order to serve as input (e.g., feature values) that will be compatible with the XGBoost model. The formats and value ranges may take various forms. For example, some contextual data may be transformed into a numeric format (e.g., integer, decimal, or fraction) and projected into a predetermined range of values (e.g., a range from zero to one, a range from zero to one hundred, etc.). As another example, some contextual data may be transformed into a categorical format based on predefined categories (e.g., categories for parts of speech, such as noun, verb, preposition, adjective, adverb, definite article, etc.). Other formats and value ranges are also possible.

Outputs of the XGBoost model may include (i) a candidate occupancy code (which may, for example, be the given textual element or a portion thereof) and (ii) a predicted likelihood that the candidate occupancy code is the true occupancy code for the given project in which the drawing that contains the candidate occupancy code is found.

The post-processing logic for this first example predictive analytics pipeline for predicting occupancy code may include logic to identify the candidate occupancy code whose corresponding predicted likelihood is greater than the predicted likelihoods for any of the other candidate occupancy code for the given project.

The post-processing logic may further include logic to output the identified candidate occupancy code as the predicted occupancy code. In addition or alternatively, the post-processing logic may further include logic to compare the predicted likelihoods of the candidate occupancy code to a threshold likelihood and output any candidate occupancy codes whose predicted likelihood exceeds (or at least equals) the threshold likelihood. If none of the predicted likelihoods of the candidate occupancy codes exceeds (or at least equals) the threshold likelihood, the post-processing logic may further include logic to output an indication that none of the candidate occupancy codes has a sufficiently high predicted likelihood.

Turning to the second example predictive analytics pipeline, the source data for this second example predictive analytics pipeline for predicting occupancy code may include one or more attribute values for the project, such as a value for the project type as defined by the OmniClass® classification system (e.g., because project types are strongly correlated with specific occupancy codes). Thus, in one example, the rule-based model may comprise a mapping that matches each possible value of project type to a corresponding occupancy code. The one or more attribute values may also take other forms. The value for the project type may be known (e.g., manually specified by a user beforehand via a user interface) or may be a value that was predicted beforehand by an attribute-specific set of predictive analytic pipelines for predicting project type (e.g., such as those described in the examples above for project type). The one or more attribute values may also take other forms.

The AI model for this second example predictive analytics pipeline for predicting occupancy code may be a rule-based model. The rule-based model may take various forms and may be generated in different ways (e.g., as described above with respect to FIG. 2). If the rule-based model comprises an association-rule model, the training data for the association-rule model may comprise a collection of training instances. Each given training instance may represent one corresponding historical and/or simulated project. Furthermore, each given training instance may comprise (i) one or more attribute values (e.g., which are actual parameters) that map to respective feature variables (e.g., formal parameters that indicate one or more respective attribute types) and (ii) a label that indicates the occupancy code of the project represented by the training instance. If an association-rule model is used, the training may involve applying an association-rule training technique such as Apriori, FP-Growth, Eclat, or some other technique that detects non-independence between the one or more attribute values and occupancy codes and leverages that non-independence to create rules for predicting occupancy code based on attribute values. Attribute values that conform to the OmniClass® classification system are strongly correlated with specific respective occupancy codes. Thus, in one example, the rule-based model may comprise a mapping that matches each possible value of project type to a corresponding occupancy code.

Inputs for the rule-based model may include the one or more attribute values from the project and, if applicable, a query that instructs the AI model to return a prediction for occupancy code based on the one or more attribute values.

Outputs of the rule-based model may include a predicted occupancy code. In addition, the AI model may also output additional information, such as one or more specific rules that were applied to determine the predicted occupancy code. Also, in examples where an association-rule model is used, one or more respective confidence levels for the one or more respective rules that were applied. For example, the confidence level for a rule may be determined by (i) identifying a number of training instances in the training data to which the rule applies and (ii) calculating the percentage of those training instances for which the rule accurately predicts the occupancy code indicated by their respective labels.

The post-processing logic for this second example predictive analytics pipeline for predicting occupancy code may include logic to compare respective confidence levels for the one or more rules that were applied to respective threshold confidence levels. If the one or more confidence levels match or exceed their respective threshold confidence levels, the post-processing logic may dictate that the second example predictive analytics pipeline for predicting occupancy code outputs the predicted occupancy code as a candidate occupancy code. Otherwise, the post-processing logic may include logic for sending a message indicating that one or more threshold conditions were not satisfied.

In line with the discussion above, in at least some implementations, an attribute-specific set of one or more predictive analytics pipelines for predicting occupancy code may include both of the foregoing examples of predictive analytics pipelines for predicting occupancy code. In such implementations, in operation, the attribute-specific set of one or more predictive analytics pipelines for predicting occupancy code may function to output multiple predicted values of the occupancy code-a first candidate occupancy code that is output by the first example predictive analytics pipeline for predicting occupancy code and a second candidate occupancy code that is output by the second example predictive analytics pipeline for predicting occupancy code. In such implementations, the back-end computing platform 102 may optionally be configured with additional logic for selecting between and/or combining the candidate occupancy codes. For example, if the candidate occupancy code output by the rule-based model is associated with a confidence level that falls below a threshold confidence level, the additional logic may select the candidate occupancy code output by the XGBoost model. On the other hand, if the candidate occupancy code output by the XGBoost model is associated with a predicted likelihood that falls below a threshold likelihood level, the additional logic may select the candidate occupancy code output by the rule-based model. In other implementations, the back-end computing platform 102 may store both candidate occupancy codes and provide an option for a user to select one of the candidate occupancy codes manually via a user interface.

Other examples of predictive analytics pipelines for predicting occupancy code may also be created in accordance with the present disclosure, including but not limited to predictive analytics pipelines that are based on other types of AI models.

### Construction Type

Turning to construction type (e.g., a project's construction type as defined by and industry standard or by the laws of one or more jurisdictions) as a seventh type of project attribute, an attribute-specific set of one or more predictive analytics pipelines for predicting construction type may include at least one predictive analytics pipeline that is based on a decision-tree model, such as a first example predictive analytics pipeline for predicting construction type that is based on a GBDT model (e.g., an XGBoost model that may be implemented via the XGBoost library that is available through GitHub®). This example of a first predictive analytics pipeline for predicting construction type will now be described in further detail.

The source data for this first example predictive analytics pipeline for predicting construction type may include drawings that are associated with a given construction project for which construction type is to be predicted. The pre-processing logic for this first example predictive analytics pipeline for predicting construction type may include logic to identify textual elements in the drawings by identifying any searchable text (e.g., stored in ASCII or Unicode encodings) that exists in the drawings and by applying OCR to identify any text that is depicted in image form. Once the textual elements have been identified, the pre-processing logic may include logic to identify textual elements that are likely to be construction types. Specifically, the pre-processing logic may include logic to identify textual elements that match a predefined pattern associated with construction types. The predefined pattern may take any of various forms. As one example, the pre-processing logic may specify that the predefined pattern is that (i) the word “type” is present, (ii) at least one whitespace character immediately precedes the word “type,” and (iii) a token that is correlated with construction type (e.g., a predefined list of tokens such as “construction,” “const,” “constr,” or “constrn”) precedes the whitespace character that precedes the word “type” in the drawing in which the upper-case letter and the token are found. The predefined pattern may also take other forms. The pre-processing logic may include logic to exclude any textual elements that do not match the predefined pattern from further consideration as potential construction types.

The pre-processing logic may further include logic to, for each given textual element that was not excluded, extract respective contextual data for the given textual element from the respective drawing in which the given textual element is found. The respective contextual data may take many forms. As one possibility, the respective contextual data may include spatial information, linguistic information, and/or relational information. In line with the discussion above, each type of contextual data may take various forms, such as the forms described above with respect to the example pipelines for predicting project title. As one example, the relational data may include information about whether any other textual elements are nearby (e.g., within a threshold distance of) the given textual element and/or whether these nearby textual elements include any words found in a predefined positive-correlation list (e.g., words that are frequently found near construction type in drawings), such as “type,” and how many of these positive-correlation words are nearby. As another example, the linguistic information may include information identifying whether the given textual element includes any predefined stop words (e.g., words that are not typically found near construction types in drawings) and/or how many of these stop words are included in the given textual element.

The AI model for this first example predictive analytics pipeline for predicting construction type may be an XGBoost model (e.g., for text classification). The XGBoost model may be trained (e.g., by the back-end computing platform 102) in the manner described above with respect to FIG. 2. The label for each given training instance in the training data for the XGBoost model indicates the construction type of a construction project (e.g., a historical project or a simulated project) corresponding to the given training instance.

Inputs for the XGBoost model (e.g., the feature variables which the XGBoost model is configured to receive as input) may comprise any combination of the contextual data described above for textual elements, such as spatial information, linguistic information, and/or relational information, among other possibilities. The contextual data may, in some instances, be formatted in various ways formats and/or projected into different ranges of values (e.g., by the pre-processing logic) in order to serve as input (e.g., feature values) that will be compatible with the XGBoost model. The formats and value ranges may take various forms. For example, some contextual data may be transformed into a numeric format (e.g., integer, decimal, or fraction) and projected into a predetermined range of values (e.g., a range from zero to one, a range from zero to one hundred, etc.). As another example, some contextual data may be transformed into a categorical format based on predefined categories (e.g., categories for parts of speech, such as noun, verb, preposition, adjective, adverb, definite article, etc.). Other formats and value ranges are also possible.

Outputs of the XGBoost model may include (i) a candidate construction type (which may, for example, be the given textual element or a portion thereof) and (ii) a predicted likelihood that the candidate construction type is the true construction type for the given project in which the drawing that contains the candidate construction type is found.

The post-processing logic for this first example predictive analytics pipeline for predicting construction type may include logic to identify the candidate construction type whose corresponding predicted likelihood is greater than the predicted likelihoods for any of the other candidate construction type for the given project.

The post-processing logic may further include logic to output the identified candidate construction type as the predicted construction type. In addition or alternatively, the post-processing logic may further include logic to compare the predicted likelihoods of the candidate construction types to a threshold likelihood and output any candidate construction types whose predicted likelihood exceeds (or at least equals) the threshold likelihood. If none of the predicted likelihoods of the candidate construction types exceeds (or at least equals) the threshold likelihood, the post-processing logic may further include logic to output an indication that none of the candidate construction types has a sufficiently high predicted likelihood.

### Work Type

Turning to work type (e.g., whether a project pertains to a renovation to an existing structure (“renovation”), an addition to an existing structure (“addition”), a new structure (“new construction”), or a shell (“shell only”)) as an eighth type of project attribute, an attribute-specific set of one or more predictive analytics pipelines for predicting work type may include a first predictive analytics pipeline that is based on a rule-based model (e.g., a trained association-rule model, a set of user-defined rules, or a hybrid model) and/or a second example predictive analytics pipeline for predicting work type that is based on a decision-tree model (e.g., a GBDT model such as an XGBoost model that may be implemented via the XGBoost library that is available through GitHub®). This example of a first predictive analytics pipeline for predicting work type will now be described in further detail.

The source data for the first example predictive analytics pipeline for predicting work type may include a plurality of attribute values for the project, such as a value for the project title, a value for the project description, one or more values for project activities (e.g., dates when daily logs, RFIs, meeting minutes, and other types of records associated with the construction project were created; site marking, excavating, welding, concreting, brick masonry, plastering, etc.), a value specifying the number of drawings associated with the project, and one or more drawing-type values (e.g., demolition, foundation, etc.) for one or more drawings associated with the project. The attribute values may be known (e.g., manually specified by a user beforehand via a user interface) or may be values that were predicted beforehand by attribute-specific sets of predictive analytic pipelines for predicting those attributes (e.g., such as those described in the examples above for project title and project description).

The pre-processing logic for this first example predictive analytics pipeline for predicting work type may include logic to retrieve the plurality of attribute values from memory or storage (e.g., via construction management software in which the project is instantiated). The pre-processing logic may also include logic for transforming the plurality of attribute values into a format that is compatible with the rule-based model. The formats and value ranges may take various forms. For example, some attribute values may be transformed into a numeric format (e.g., integer, decimal, or fraction) and projected into a predetermined range of values (e.g., a range from zero to one, a range from zero to one hundred, etc.). As another example, some attribute values may be transformed into a categorical format based on predefined categories. Other formats and value ranges are also possible. Furthermore, the pre-processing logic may include logic to generate a query in a query syntax that the AI model is configured to parse. The query may instruct the AI model to return a prediction for work type based on the plurality of attribute values.

The pre-processing logic may also include logic to apply a technique for predicting the titles for drawings to determine drawing-title values. Such a technique may take any of various forms. For example, the pre-processing logic may include logic to apply one or more techniques for predicting drawing title that are found in U.S. application Ser. No. 17/408,0502, “Machine-Learning-Based Identification of Drawing Attributes,” which is hereby incorporated by reference in its entirety. Techniques for predicting the title of a drawing may also take other forms.

The AI model for this first example predictive analytics pipeline for predicting work type may be a rule-based model. The rule-based model may take various forms and may be generated in different ways (e.g., as described above with respect to FIG. 2). If the rule-based model comprises an association-rule model, the training data for the association-rule model may be derived from historical projects and/or simulated projects whose work-type values are known (e.g., verified and treated as ground-truth data). The training data may comprise a collection of training instances. Each given training instance may represent one of the historical and/or simulated projects. Furthermore, each given training instance may comprise (i) the attribute values (e.g., which are actual parameters) that map to respective feature variables (e.g., formal parameters that indicate the attribute types such as project activity, project description, etc.) for the association-rule model and (ii) a label that indicates the work-type value of the project represented by the training instance. As noted above, if an association-rule model is used, the training may involve applying an association-rule training technique such as Apriori, FP-Growth, Eclat, or some other technique that detects non-independence between attribute values and work-type values and leverages that non-independence to create rules for predicting work-type based on attribute values. The rules may take many forms. For example, one rule may specify that projects which do not include any drawings of the drawing type “foundation” are predicted to have a work-type value of “renovation,” while another rule may specify that projects that include an activity value of “demolition” are predicted to have a work-type value of “new construction.” The rules may also take any of various other forms.

Inputs for the rule-based model may include the plurality of attribute values from the project and, if applicable, a query that instructs the AI model to return a prediction for work type based on the plurality of attribute values.

Outputs of the rule-based model may include a predicted work-type value. In addition, the AI model may also output additional information, such as one or more specific rules that were applied to determine the predicted work-type value. Also, in examples where an association-rule model is used, one or more respective confidence levels for the one or more respective rules that were applied. For example, the confidence level for a rule may be determined by (i) identifying a number of training instances in the training data to which the rule applies and (ii) calculating the percentage of those training instances for which the rule accurately predicts the work-type values indicated by their respective labels.

The post-processing logic for this first example predictive analytics pipeline for predicting work type may include logic to compare respective confidence levels for the one or more rules that were applied to respective threshold confidence levels. If the one or more confidence levels match or exceed their respective threshold confidence levels, the post-processing logic may dictate that the first example predictive analytics pipeline for predicting work-type values outputs the predicted work-type value as a candidate work-type value. Otherwise, the post-processing logic may include logic for sending a message indicating that one or more threshold conditions were not satisfied.

Turning to the second example predictive analytics pipeline for predicting work type, the source data for this second example predictive analytics pipeline for predicting work type may include drawings that are associated with a given construction project for which work type is to be predicted. In addition, the source data may include attribute values for the given project, such as attribute values for project activities, project trades, project title, and project description. The pre-processing logic for this second example predictive analytics pipeline for predicting work type may include logic to identify types of the drawings and to vectorize textual elements found in the project title and the project description and to add any categorical features associated with those textual elements.

The AI model for this first example predictive analytics pipeline for predicting work type may be an XGBoost model (e.g., for text classification). The XGBoost model may be trained (e.g., by the back-end computing platform 102) in the manner described above with respect to FIG. 2. The label for each given training instance in the training data for the XGBoost model indicates the work type of a construction project (e.g., a historical project or a simulated project) corresponding to the given training instance. Each label may represent ground-truth or may be a prediction that was output by the first example predictive analytics pipeline for predicting work type.

Inputs for the XGBoost model (e.g., the feature variables which the XGBoost model is configured to receive as input) may comprise any the types of the drawings included in the source data for the given project and the attribute values noted above for the given project.

Outputs of the XGBoost model may include (i) a candidate work type (which may, for example, be the given textual element or a portion thereof) value and (ii) a predicted likelihood that the candidate work-type value is the true work-type value for the given project.

The post-processing logic for this second example predictive analytics pipeline for predicting work type may include logic to identify the candidate work-type value whose corresponding predicted likelihood is greater than the predicted likelihoods for any of the other candidate work-type values for the given project.

The post-processing logic may further include logic to output the identified candidate work-type value as the predicted work-type value. In addition or alternatively, the post-processing logic may further include logic to compare the predicted likelihoods of the candidate work-type values to a threshold likelihood and output any candidate work types whose predicted likelihood exceeds (or at least equals) the threshold likelihood. If none of the predicted likelihoods of the candidate work-type values exceeds (or at least equals) the threshold likelihood, the post-processing logic may further include logic to output an indication that none of the candidate work-type values has a sufficiently high predicted likelihood.

Other examples of predictive analytics pipelines for predicting work type may also be created in accordance with the present disclosure, including but not limited to predictive analytics pipelines that are based on other types of AI models.

### Number of Total Floors

Turning to number of total floors (e.g., the number of stories in a structure to which a project pertains) as a ninth type of project attribute, an attribute-specific set of one or more predictive analytics pipelines for predicting number of total floors may include a first predictive analytics pipeline that is based on a decision-tree model (e.g., a GBDT model such as an XGBoost model), a second example predictive analytics pipeline for predicting number of total floors that is based on a rule-based model (e.g., a trained association-rule model or a set of user-defined rules), a third example predictive analytics pipeline that is based on an LLM (e.g., a GPT model), and/or a fourth example predictive analytics pipeline that is based on a computer-vision model (e.g., a hierarchical vision transformer classification model). These examples of predictive analytics pipelines for predicting number of total floors will now be described in further detail.

The source data for this first example predictive analytics pipeline for predicting number of total floors may include drawings that are associated with a given construction project for which number of total floors is to be predicted. The pre-processing logic for this first example predictive analytics pipeline for predicting number of total floors may include logic to identify textual elements in the drawings by identifying any searchable text (e.g., stored in ASCII or Unicode encodings) that exists in the drawings and by applying OCR to identify any text that is depicted in image form. Once the textual elements have been identified, the pre-processing logic may include logic to identify textual elements that are likely to specify the number of total floors. Specifically, the pre-processing logic may include logic to identify textual elements that match a predefined pattern associated with numbers of total floors. The predefined pattern may take any of various forms. As one example, the pre-processing logic may specify that the predefined pattern is that (i) the word “floor” is present, (ii) a first number follows the word “floor,” (iii) a slash (e.g., back slash or forward slash) follows the first number, and (iv) a second number that is greater than or equal to the first number follows the slash in the drawing in which the upper-case letter and the token are found. The predefined pattern may also take other forms. The pre-processing logic may include logic to exclude any textual elements that do not match the predefined pattern from further consideration as potential numbers of total floors.

The pre-processing logic may further include logic to, for each given textual element that was not excluded, extract respective contextual data for the given textual element from the respective drawing in which the given textual element is found. The respective contextual data may take many forms. As one possibility, the respective contextual data may include spatial information, linguistic information, and/or relational information. In line with the discussion above, each type of contextual data may take various forms, such as the forms described above with respect to the example pipelines for predicting project title. As one example, the relational data may include information about whether any other textual elements are nearby (e.g., within a threshold distance of) the given textual element and/or whether these nearby textual elements include any words found in a predefined positive-correlation list (e.g., words that are frequently found near number of total floors in drawings), such as “story” or “storey” and how many of these positive-correlation words are nearby. As another example, the linguistic information may include information identifying whether the given textual element includes any predefined stop words (e.g., words that are not typically found near numbers of total floors in drawings) and/or how many of these stop words are included in the given textual element.

The AI model for this first example predictive analytics pipeline for predicting number of total floors may be an XGBoost model (e.g., for text classification). The training data for the XGBoost model may comprise a collection of training instances. Each given training instance may comprise (i) feature values (e.g., actual parameters) that map to respective feature variables (e.g., formal parameters) which the XGBoost model is configured to receive as input and (ii) a label that indicates whether the given textual element represented by the given training instance is a number of total floors. The back-end computing platform 102 trains the XGBoost model in in the manner described above with respect to FIG. 2.

Inputs for the XGBoost model (e.g., the feature variables which the XGBoost model is configured to receive as input) may comprise any combination of the contextual data described above for textual elements, such as spatial information, linguistic information, and/or relational information, among other possibilities. The contextual data may, in some instances, be formatted in various ways formats and/or projected into different ranges of values (e.g., by the pre-processing logic) in order to serve as input (e.g., feature values) that will be compatible with the XGBoost model. The formats and value ranges may take various forms. For example, some contextual data may be transformed into a numeric format (e.g., integer, decimal, or fraction) and projected into a predetermined range of values (e.g., a range from zero to one, a range from zero to one hundred, etc.). As another example, some contextual data may be transformed into a categorical format based on predefined categories (e.g., categories for parts of speech, such as noun, verb, preposition, adjective, adverb, definite article, etc.). Other formats and value ranges are also possible.

Outputs of the XGBoost model may include (i) a candidate number of total floors (which may, for example, be the given textual element or a portion thereof) and (ii) a predicted likelihood that the candidate number of total floors is the true number of total floors for the given project in which the drawing that contains the candidate number of total floors is found.

The post-processing logic for this first example predictive analytics pipeline for predicting number of total floors may include logic to identify the candidate number of total floors whose corresponding predicted likelihood is greater than the predicted likelihoods for any of the other candidate numbers of total floors for the given project.

The post-processing logic may further include logic to output the identified candidate number of total floors as the predicted number of total floors. In addition or alternatively, the post-processing logic may further include logic to compare the predicted likelihoods of the numbers of total floors to a threshold likelihood and output any candidate numbers of total floors whose predicted likelihood exceeds (or at least equals) the threshold likelihood. If none of the predicted likelihoods of the candidate numbers of total floors exceeds (or at least equals) the threshold likelihood, the post-processing logic may further include logic to output an indication that none of the candidate numbers of total floors has a sufficiently high predicted likelihood.

Turning to the second example predictive analytics pipeline for predicting number of total floors, the source data for the second example predictive analytics pipeline for predicting number of total floors may include a set of drawings associated with the given project for which a prediction is to be made.

The pre-processing logic for this second example predictive analytics pipeline for predicting number of total floors may include logic for retrieving the titles of the drawings in the set that are readily stored in a computer-readable format (e.g., in a database or in metadata). If the set includes drawings whose titles have yet to be extracted (e.g., drawings that were scanned from paper originals and have not yet been subjected to OCR), the pre-processing logic may include logic to apply a technique for predicting the titles for those drawings. Such a technique may take any of various forms. For example, the pre-processing logic may include logic to apply one or more techniques for predicting drawing title (e.g., such as that are found in U.S. application Ser. No. 17/408,0502, which was incorporated by reference above). The technique for predicting the title of a drawing may also take other forms.

The AI model for this second example predictive analytics pipeline for predicting number of total floors may be a rule-based model. The rule-based model may take various forms and may be generated in different ways (e.g., as described above with respect to FIG. 2). If the rule-based model comprises an association-rule model, the training data for the association-rule model may comprise a collection of training instances. Each given training instance may represent one corresponding historical and/or simulated project. Furthermore, each given training instance may comprise (i) titles for the drawings in the set and (ii) a label that indicates the number of total floors for the project represented by the training instance.

The rules included in the rule-based model may take any of various forms. For example, the rules may include logic to identify floor numbers listed in the drawing titles and to select the highest floor number found. In another example, the rules may include logic to determine a sum that is increased by one for each unique floor number found in the drawing titles.

Inputs for the rule-based model may include the drawing titles for the drawings in the set.

Outputs of the rule-based model may include a predicted number of total floors. In addition, the AI model may also output additional information, such as one or more specific rules that were applied to determine the predicted number of total floors. Also, in examples where an association-rule model is used, the output may include one or more respective confidence levels for the one or more respective rules that were applied. For example, the confidence level for a rule may be determined by (i) identifying a number of training instances in the training data to which the rule applies and (ii) calculating the percentage of those training instances for which the rule accurately predicts the number of total floors indicated by their respective labels.

The post-processing logic for this second example predictive analytics pipeline for predicting number of total floors may include logic to compare respective confidence levels for the one or more rules that were applied to respective threshold confidence levels. If the one or more confidence levels match or exceed their respective threshold confidence levels, the post-processing logic may dictate that the second example predictive analytics pipeline for predicting number of total floors outputs the predicted number of total floors as a candidate number of total floors values. Otherwise, the post-processing logic may include logic for sending a message indicating that one or more threshold conditions were not satisfied.

Turning to the third example predictive analytics pipeline for predicting number of total floors, the source data for this third example predictive analytics pipeline may include a plurality of drawing titles of drawings found in the project for which the number of total floors is to be predicted.

The pre-processing logic for this third example predictive analytics pipeline for predicting number of total floors may further logic for identifying drawings found in the project. If the titles of the drawings are readily stored in a computer-readable format (e.g., in a database or in metadata), the pre-processing logic may include logic to retrieve the titles from storage (e.g., via a database query). If the project includes drawings whose titles have yet to be extracted (e.g., drawings that were scanned from paper originals and have not yet been subjected to OCR), the pre-processing logic may include logic to apply a technique for predicting the titles for those drawings. Such a technique may take any of various forms. For example, the pre-processing logic may include logic to apply one or more techniques for predicting drawing title (e.g., such as that are found in U.S. application Ser. No. 17/408,0502, which was incorporated by reference above). The technique for predicting the title of a drawing may also take other forms.

The pre-processing logic for this third example predictive analytics pipeline for predicting number of total floors may further include logic for generating a prompt that is to be submitted to the AI model for this third example predictive analytics pipeline along with the plurality of drawing titles. The prompt may take various forms. For example, the prompt may be a natural-language request for the AI model to predict the number of total floors of the project based on the plurality of drawing titles. The prompt may also take other forms (e.g., forms that conform to a grammar that does not match any natural language).

The AI model for this third example predictive analytics pipeline for predicting number of total floors may be a GPT model that is configured for question answering. The GPT model for this second example predictive analytics pipeline may be trained via a pre-training phase (e.g., as described above with respect to FIG. 2). Optionally, the GPT model may also be trained via an optional fine-tuning phase as described above with respect to FIG. 2. If such the fine-tuning phase is performed, the label for each given training instance in the training data indicates the number of total floors for a construction project (e.g., a historical project or a simulated project) that corresponds to the given training instance.

Turning to the fourth example predictive analytics pipeline for predicting number of total floors, the source data for this fourth example predictive analytics pipeline may include a plurality of drawings-specifically, drawings that are floor plans.

The pre-processing logic may include logic to select a set of drawings that are floor plans from a larger set of drawings for a project. The larger set of drawings may include drawings of many different types. The pre-processing logic may include logic to identify drawings that are floor plans based on metadata in the drawings themselves (e.g., metadata that explicitly specifies the drawings are floor plans). For drawings that lack such metadata, the pre-processing logic may include logic to perform OCR and search the OCR text for one or more tokens that are strongly correlated with floor plans (e.g., such as the token “floor plan”). Based on the tokens identified, the pre-processing logic may include logic to include drawings that have many strongly correlated tokens in the set of drawings (and to exclude drawings that lack strongly correlated tokens or that have many tokens that are more strongly correlated with other types of drawings).

The AI model for this fourth example predictive analytics pipeline for predicting number of total floors may include a computer-vision model (e.g., a hierarchical vision transformer classification model). The training data for the computer-vision model may comprise a plurality of training instances. Each given training instance may represent a respective project and may include (i) a plurality of drawings that are floor plans included in the respective project and (ii) a label that indicates a location hierarchy for spaces depicted in the plurality of drawings. Floor identifiers are included in the location hierarchy.

The training data may be derived from historical projects and/or simulated projects whose location hierarchies are known (e.g., verified and treated as ground-truth data). The training data includes a plurality of training instances whose labels indicate respective location hierarchies for the historical projects and/or simulated projects.

The computer-vision model may be trained in the following manner. The computer-vision model (i) receives each given training instance as input, (ii) predicts a location hierarchy for the respective project corresponding to the training instance based on the plurality of drawings found in the given training instance, (iii) compares the predicted location hierarchy to the label found in the given training instance, and (iv) adjusts model parameters (e.g., the weights and biases found in different layers of the computer-vision model) within the computer-vision model based on any difference that exists between the predicted location hierarchy and the location hierarchy indicated by the label.

As noted above, the inputs for the computer-vision model may comprise a plurality of drawings that are floor plans. The output of the computer-vision model may comprise a predicted location hierarchy for the given project that corresponds to the inputs.

The post-processing logic for this fourth example predictive analytics pipeline for predicting number of total floors may include logic to calculate a respective number of total floors for the given project based on the predicted location hierarchy. For example, the post-processing logic may include logic to (i) determine the number of total floors by counting the total number of unique floor identifiers included in the predicted location hierarchy and (ii) output the total number of unique floor identifiers as the predicted number of total floors. In another example, the floor identifiers included in the location hierarchy comprise respective floor numbers and the post-processing logic may (i) identify an upper-bound respective floor number that is higher than any of the other respective floor numbers included in the floor identifiers and (ii) output the upper-bound respective floor number as the predicted number of total floors.

In line with the discussion above, in at least some implementations, an attribute-specific set of one or more predictive analytics pipelines for predicting number of total floors may include the four foregoing examples of predictive analytics pipelines for predicting number of total floors. In such implementations, in operation, the attribute-specific set of one or more predictive analytics pipelines for predicting number of total floors may function to output multiple predicted values of the number of total floors-a first candidate number of total floors that is output by the first example predictive analytics pipeline for predicting number of total floors, a second candidate number of total floors that is output by the second example predictive analytics pipeline for predicting number of total floors, a third candidate number of total floors that is output by the third example predictive analytics pipeline for predicting number of total floors, and a fourth candidate number of total floors that is output by the fourth example predictive analytics pipeline for predicting number of total floors. In such implementations, the back-end computing platform 102 may optionally be configured with additional logic for selecting between and/or combining the candidate numbers of total floors. In other implementations, the back-end computing platform 102 may store the four candidate numbers of total floors and provide an option for a user to select one of the candidate numbers of floors manually via a user interface.

Other examples of predictive analytics pipelines for predicting number of total floors may also be created in accordance with the present disclosure, including but not limited to predictive analytics pipelines that are based on other types of AI models.

### Number of Floors Above Ground

Turning to number of floors above ground (e.g., the number of stories that are at or above ground level in a structure to which a project pertains) as a tenth type of project attribute, an attribute-specific set of one or more predictive analytics pipelines for predicting number of floors above ground may include a first predictive analytics pipeline that is based on a rule-based model (e.g., a trained association-rule model or a set of user-defined rules), a second example predictive analytics pipeline that is based on an LLM (e.g., a GPT model), and/or a third example predictive analytics pipeline that is based on a computer-vision model (e.g., a hierarchical vision transformer classification model). These examples of predictive analytics pipelines for predicting number of floors above ground will now be described in further detail.

The source data for the first example predictive analytics pipeline for predicting number of floors above ground may include a set of drawings associated with the given project for which a prediction is to be made.

The pre-processing logic for this first example predictive analytics pipeline for predicting number of floors above ground may include logic for retrieving the titles of the drawings in the set that are readily stored in a computer-readable format (e.g., in a database or in metadata). If the set includes drawings whose titles have yet to be extracted (e.g., drawings that were scanned from paper originals and have not yet been subjected to OCR), the pre-processing logic may include logic to apply a technique for predicting the titles for those drawings. Such a technique may take any of various forms. For example, the pre-processing logic may include logic to apply one or more techniques for predicting drawing title (e.g., such as that are found in U.S. application Ser. No. 17/408,0502, which was incorporated by reference above). The technique for predicting the title of a drawing may also take other forms.

The AI model for this first example predictive analytics pipeline for predicting number of floors above ground may be a rule-based model. The rule-based model may take various forms and may be generated in different ways (e.g., as described above with respect to FIG. 2). If the rule-based model comprises an association-rule model, the training data for the association-rule model may comprise a collection of training instances. Each given training instance may represent one corresponding historical and/or simulated project. Furthermore, each given training instance may comprise (i) titles for the drawings in the set and (ii) a label that indicates the number of floors above ground for the project represented by the training instance.

The rules included in the rule-based model may take any of various forms. For example, the rules may include logic to identify floor numbers listed in the drawing titles and to select the highest floor number found. In another example, the rules may include logic to determine a sum that is increased by one for each unique floor number found in the drawing titles.

Inputs for the rule-based model may include the drawing titles for the drawings in the set.

Outputs of the rule-based model may include a predicted number of floors above ground. In addition, the AI model may also output additional information, such as one or more specific rules that were applied to determine the predicted number of floors above ground. Also, in examples where an association-rule model is used, the output may include one or more respective confidence levels for the one or more respective rules that were applied. For example, the confidence level for a rule may be determined by (i) identifying a number of training instances in the training data to which the rule applies and (ii) calculating the percentage of those training instances for which the rule accurately predicts the number of floors above ground indicated by their respective labels.

The post-processing logic for this first example predictive analytics pipeline for predicting number of floors above ground may include logic to compare respective confidence levels for the one or more rules that were applied to respective threshold confidence levels. If the one or more confidence levels match or exceed their respective threshold confidence levels, the post-processing logic may dictate that the second example predictive analytics pipeline for predicting number of floors above ground outputs the predicted project type as a candidate number of floors above ground values. Otherwise, the post-processing logic may dictate a message indicating that one or more threshold conditions were not satisfied.

Turning to the second example predictive analytics pipeline for predicting number of floors above ground, the source data for this second example predictive analytics pipeline may include a plurality of drawing titles of drawings found in the project for which the number of floors above ground is to be predicted.

The pre-processing logic for this second example predictive analytics pipeline for predicting number of floors above ground may further logic for identifying drawings found in the project. If the titles of the drawings are readily stored in a computer-readable format (e.g., in a database or in metadata), the pre-processing logic may include logic to retrieve the titles from storage (e.g., via a database query). If the project includes drawings whose titles have yet to be extracted (e.g., drawings that were scanned from paper originals and have not yet been subjected to OCR), the pre-processing logic may include logic to apply a technique for predicting the titles for those drawings. Such a technique may take any of various forms (e.g., a form described in U.S. application Ser. No. 17/408,0502, which was incorporated by reference above, or some other form).

The pre-processing logic for this second example predictive analytics pipeline for predicting number of floors above ground may further include logic for generating a prompt that is to be submitted to the AI model for this second example predictive analytics pipeline along with the plurality of drawing titles. The prompt may take various forms. For example, the prompt may be a natural-language request for the AI model to predict the number of floors above ground of the project based on the plurality of drawing titles. The prompt may also take other forms (e.g., forms that conform to a grammar that does not match any natural language).

The AI model for this second example predictive analytics pipeline for predicting number of floors above ground may be a GPT model that is configured for question answering. The GPT model for this second example predictive analytics pipeline may be trained via a pre-training phase (e.g., as described above with respect to FIG. 2). Optionally, the GPT model may also be trained via an optional fine-tuning phase as described above with respect to FIG. 2. If such the fine-tuning phase is performed, the label for each given training instance in the training data indicates the number of floors above ground for a construction project (e.g., a historical project or a simulated project) that corresponds to the given training instance.

As noted above, the inputs for the GPT model may comprise a plurality of drawing titles for the drawings found in a project and a prompt that requests that the GPT model predict the project's number of floors above ground based on the plurality of drawing titles. The output of the GPT model may comprise a candidate number of floors above ground identified or generated by the GPT model. The GPT model for this second example predictive analytics pipeline might not output a confidence score for the candidate number of floors above ground. As a result, the second example predictive analytics pipeline for predicting number of floors above ground may output the candidate number of floors above ground directly without applying any post-processing logic (e.g., the second example predictive pipeline may not have to include any post-processing logic.) Alternatively, the second example predictive analytics pipeline for predicting number of floors above ground may include some post-processing logic for handling scenarios in which the GPT model fails to output a candidate number of floors above ground (e.g., if the GPT model simply outputs an error message or a message saying that there is insufficient data to make a prediction, the post-processing logic may output an indication that the attempt to predict the number of floors above ground failed).

Turning to the third example predictive analytics pipeline for predicting number of floors above ground, the source data for this third example predictive analytics pipeline may include a plurality of drawings-specifically, drawings that are floor plans.

The pre-processing logic may include logic to select a set of drawings that are floor plans from a larger set of drawings for a project. The larger set of drawings may include drawings of many different types. The pre-processing logic may include logic to identify drawings that are floor plans based on metadata in the drawings themselves (e.g., metadata that explicitly specifies the drawings are floor plans). For drawings that lack such metadata, the pre-processing logic may include logic to perform OCR and search the OCR text for one or more tokens that are strongly correlated with floor plans (e.g., such as the token “floor plan”). Based on the tokens identified, the pre-processing logic may include logic to include drawings that have many strongly correlated tokens in the set of drawings (and to exclude drawings that lack strongly correlated tokens or that have many tokens that are more strongly correlated with other types of drawings).

The AI model for this third example predictive analytics pipeline for predicting number of floors above ground may include a computer-vision model (e.g., a hierarchical vision transformer classification model). The training data for the computer-vision model may comprise a plurality of training instances. Each given training instance may represent a respective project and may include (i) a plurality of drawings that are floor plans included in the respective project and (ii) a label that indicates a location hierarchy for spaces depicted in the plurality of drawings. Floor identifiers are included in the location hierarchy.

The training data may be derived from historical projects and/or simulated projects whose location hierarchies are known (e.g., verified and treated as ground-truth data). The training data includes a plurality of training instances whose labels indicate respective location hierarchies for the historical projects and/or simulated projects.

The computer-vision model may be trained in the following manner. The computer-vision model (i) receives each given training instance as input, (ii) predicts a location hierarchy for the respective project corresponding to the training instance based on the plurality of drawings found in the given training instance, (iii) compares the predicted location hierarchy to the label found in the given training instance, and (iv) adjusts model parameters (e.g., the weights and biases found in different layers of the computer-vision model) within the computer-vision model based on any difference that exists between the predicted location hierarchy and the location hierarchy indicated by the label.

As noted above, the inputs for the computer-vision model may comprise a plurality of drawings that are floor plans. The output of the computer-vision model may comprise a predicted location hierarchy for the given project that corresponds to the inputs.

The post-processing logic for this third example predictive analytics pipeline for predicting number of floors above ground may include logic to calculate a respective number of floors above ground for the given project based on the predicted location hierarchy. For example, the post-processing logic may include logic to determine the number of floors above ground by counting the total number of unique floor identifiers included in the predicted location hierarchy that match a pattern associated with floors above ground. For example, the pattern may be that the floor identifier includes a floor number that is not immediately preceded or followed by any tokens that are commonly used in identifiers of below-ground floors (e.g., tokens such as “B,” “Basement,” “LL,” “Lower Level,” “Lower Lobby,” “C,” “Cellar,” “U,” “Underground,” etc.). The post-processing logic may further include logic to output the total number of unique floor identifiers that match the pattern as the predicted number of floors above ground. In another example, the floor identifiers included in the location hierarchy comprise respective floor numbers and the post-processing logic may (i) identify an upper-bound respective floor number that matches the pattern and is higher than any of the other respective floor numbers that match the pattern and (ii) output the upper-bound respective floor number as the predicted number of floors above ground.

In line with the discussion above, in at least some implementations, an attribute-specific set of one or more predictive analytics pipelines for predicting number of floors above ground may include the three foregoing examples of predictive analytics pipelines for predicting number of floors above ground. In such implementations, in operation, the attribute-specific set of one or more predictive analytics pipelines for predicting number of floors above ground may function to output multiple predicted values of the number of floors above ground-a first candidate number of floors above ground that is output by the first example predictive analytics pipeline for predicting number of floors above ground, a second candidate number of floors above ground that is output by the second example predictive analytics pipeline for predicting number of floors above ground, and a third candidate number of floors above ground that is output by the third example predictive analytics pipeline for predicting number of floors above ground. In such implementations, the back-end computing platform 102 may optionally be configured with additional logic for selecting between and/or combining the candidate numbers of floors above ground. In other implementations, the back-end computing platform 102 may store the three candidate numbers of floors above ground and provide an option for a user to select one of the candidate numbers of floors above ground manually via a user interface.

Other examples of predictive analytics pipelines for predicting number of floors above ground may also be created in accordance with the present disclosure, including but not limited to predictive analytics pipelines that are based on other types of AI models.

### Number of Floors Below Ground

Turning to number of floors below ground (e.g., the number of stories that are below ground level in a structure to which a project pertains) as an eleventh type of project attribute, an attribute-specific set of one or more predictive analytics pipelines for predicting number of floors below ground may include a first predictive analytics pipeline that is based on a rule-based model (e.g., a trained association-rule model or a set of user-defined rules), a second example predictive analytics pipeline that is based on an LLM (e.g., a GPT model), and/or a third example predictive analytics pipeline that is based on a computer-vision model. These examples of predictive analytics pipelines for predicting number of floors below ground will now be described in further detail.

The source data for the first example predictive analytics pipeline for predicting number of floors below ground may include a set of drawings associated with the given project for which a prediction is to be made.

The pre-processing logic for this first example predictive analytics pipeline for predicting number of floors below ground may include logic for retrieving the titles of the drawings in the set that are readily stored in a computer-readable format (e.g., in a database or in metadata). If the set includes drawings whose titles have yet to be extracted (e.g., drawings that were scanned from paper originals and have not yet been subjected to OCR), the pre-processing logic may include logic to apply a technique for predicting the titles for those drawings. Such a technique may take any of various forms. For example, the pre-processing logic may include logic to apply one or more techniques for predicting drawing title (e.g., such as that are found in U.S. application Ser. No. 17/408,0502, which was incorporated by reference above). The technique for predicting the title of a drawing may also take other forms.

The AI model for this first example predictive analytics pipeline for predicting number of floors below ground may be a rule-based model. The rule-based model may take various forms and may be generated in different ways (e.g., as described above with respect to FIG. 2). If the rule-based model comprises an association-rule model, the training data for the association-rule model may comprise a collection of training instances. Each given training instance may represent one corresponding historical and/or simulated project. Furthermore, each given training instance may comprise (i) titles for the drawings in the set and (ii) a label that indicates the number of floors below ground for the project represented by the training instance.

The rules included in the rule-based model may take any of various forms. For example, The rules may include one or more rules for determining whether each title of a drawing associated with a given project indicates that the drawing depicts a below-ground floor. For example, one or more rules may dictate that a title that includes at least one digit that is immediately preceded or followed by a token that is commonly used in identifiers of below-ground floors (e.g., tokens such as “B,” “Basement,” “LL,” “Lower Level,” “Lower Lobby,” “C,” “Cellar,” “U,” “Underground,” etc.) indicates that the drawing depicts a below-ground floor in the given project.

Inputs for the rule-based model may include the drawing titles for the drawings in the set.

Outputs of the rule-based model may include, for each respective title for respective drawing in the set, a respective prediction of whether the respective drawing depicts a below-ground floor.

The post-processing logic for this first example predictive analytics pipeline for predicting number of floors below ground may include logic to (i) count the total number of respective drawings that are predicted to depict below-ground floors and (ii) output that total number.

Turning to the second example predictive analytics pipeline for predicting number of floors below ground, the source data for this second example predictive analytics pipeline may include a plurality of drawing titles of drawings found in the project for which the number of floors below ground is to be predicted.

The pre-processing logic for this second example predictive analytics pipeline for predicting number of floors below ground may further logic for identifying drawings found in the project. If the titles of the drawings are readily stored in a computer-readable format (e.g., in a database or in metadata), the pre-processing logic may include logic to retrieve the titles from storage (e.g., via a database query). If the project includes drawings whose titles have yet to be extracted (e.g., drawings that were scanned from paper originals and have not yet been subjected to OCR), the pre-processing logic may include logic to apply a technique for predicting the titles for those drawings. Such a technique may take any of various forms (e.g., a form described in U.S. application Ser. No. 17/408,0502, which was incorporated by reference above, or some other form).

The pre-processing logic for this second example predictive analytics pipeline for predicting number of floors below ground may further include logic for generating a prompt that is to be submitted to the AI model for this second example predictive analytics pipeline along with the plurality of drawing titles. The prompt may take various forms. For example, the prompt may be a natural-language request for the AI model to predict the number of floors below ground of the project based on the plurality of drawing titles. The prompt may also take other forms (e.g., forms that conform to a grammar that does not match any natural language).

The AI model for this second example predictive analytics pipeline for predicting number of floors below ground may be a GPT model that is configured for question answering. The GPT model for this second example predictive analytics pipeline may be trained via a pre-training phase (e.g., as described above with respect to FIG. 2). Optionally, the GPT model may also be trained via an optional fine-tuning phase as described above with respect to FIG. 2. If such the fine-tuning phase is performed, the label for each given training instance in the training data indicates the number of floors below ground for a construction project (e.g., a historical project or a simulated project) that corresponds to the given training instance.

As noted above, the inputs for the GPT model may comprise a plurality of drawing titles for the drawings found in a project and a prompt that requests that the GPT model predict the project's number of floors below ground based on the plurality of drawing titles. The output of the GPT model may comprise a candidate number of floors below ground identified or generated by the GPT model. The GPT model for this second example predictive analytics pipeline might not output a confidence score for the candidate number of floors below ground. As a result, the second example predictive analytics pipeline for predicting number of floors below ground may output the candidate number of floors below ground directly without applying any post-processing logic (e.g., the second example predictive pipeline may not have to include any post-processing logic.) Alternatively, the second example predictive analytics pipeline for predicting number of floors below ground may include some post-processing logic for handling scenarios in which the GPT model fails to output a candidate number of floors below ground (e.g., if the GPT model simply outputs an error message or a message saying that there is insufficient data to make a prediction, the post-processing logic may output an indication that the attempt to predict the number of floors below ground failed).

Turning to the third example predictive analytics pipeline for predicting number of floors below ground, the source data for this third example predictive analytics pipeline may include a plurality of drawings-specifically, drawings that are floor plans.

The pre-processing logic may include logic to select a set of drawings that are floor plans from a larger set of drawings for a project. The larger set of drawings may include drawings of many different types. The pre-processing logic may include logic to identify drawings that are floor plans based on metadata in the drawings themselves (e.g., metadata that explicitly specifies the drawings are floor plans). For drawings that lack such metadata, the pre-processing logic may include logic to perform OCR and search the OCR text for one or more tokens that are strongly correlated with floor plans (e.g., such as the token “floor plan”). Based on the tokens identified, the pre-processing logic may include logic to include drawings that have many strongly correlated tokens in the set of drawings (and to exclude drawings that lack strongly correlated tokens or that have many tokens that are more strongly correlated with other types of drawings).

The AI model for this third example predictive analytics pipeline for predicting number of floors below ground may include a computer-vision model (e.g., a hierarchical vision transformer classification model). The training data for the computer-vision model may comprise a plurality of training instances. Each given training instance may represent a respective project and may include (i) a plurality of drawings that are floor plans included in the respective project and (ii) a label that indicates a location hierarchy for spaces depicted in the plurality of drawings. Floor identifiers are included in the location hierarchy.

The training data may be derived from historical projects and/or simulated projects whose location hierarchies are known (e.g., verified and treated as ground-truth data). The training data includes a plurality of training instances whose labels indicate respective location hierarchies for the historical projects and/or simulated projects.

The computer-vision model may be trained in the following manner. The computer-vision model (i) receives each given training instance as input, (ii) predicts a location hierarchy for the respective project corresponding to the training instance based on the plurality of drawings found in the given training instance, (iii) compares the predicted location hierarchy to the label found in the given training instance, and (iv) adjusts model parameters (e.g., the weights and biases found in different layers of the computer-vision model) within the computer-vision model based on any difference that exists between the predicted location hierarchy and the location hierarchy indicated by the label.

As noted above, the inputs for the computer-vision model may comprise a plurality of drawings that are floor plans. The output of the computer-vision model may comprise a predicted location hierarchy for the given project that corresponds to the inputs.

The post-processing logic for this third example predictive analytics pipeline for predicting number of floors below ground may include logic to calculate a respective number of floors below ground for the given project based on the predicted location hierarchy. For example, the post-processing logic may include logic to determine the number of floors below ground by counting the total number of unique floor identifiers included in the predicted location hierarchy that match a pattern associated with floors below ground. For example, the pattern may be that the floor identifier includes a floor number that is immediately preceded or followed by at least one token that is commonly used in identifiers of below-ground floors (e.g., tokens such as “B,” “Basement,” “LL,” “Lower Level,” “Lower Lobby,” “C,” “Cellar,” “U,” “Underground,” etc.). The post-processing logic may further include logic to output the total number of unique floor identifiers that match the pattern as the predicted number of floors below ground.

In line with the discussion above, in at least some implementations, an attribute-specific set of one or more predictive analytics pipelines for predicting number of floors below ground may include the three foregoing examples of predictive analytics pipelines for predicting number of floors below ground. In such implementations, in operation, the attribute-specific set of one or more predictive analytics pipelines for predicting number of floors below ground may function to output multiple predicted values of the number of floors below ground-a first candidate number of floors below ground that is output by the first example predictive analytics pipeline for predicting number of floors below ground, a second candidate number of floors below ground that is output by the second example predictive analytics pipeline for predicting number of floors below ground, and a third candidate number of floors below ground that is output by the third example predictive analytics pipeline for predicting number of floors below ground. In such implementations, the back-end computing platform 102 may optionally be configured with additional logic for selecting between and/or combining the candidate numbers of floors below ground. In other implementations, the back-end computing platform 102 may store the three candidate numbers of floors below ground and provide an option for a user to select one of the candidate numbers of floors below ground manually via a user interface.

Other examples of predictive analytics pipelines for predicting number of floors below ground may also be created in accordance with the present disclosure, including but not limited to predictive analytics pipelines that are based on other types of AI models.

### Number of Units

Turning to number of units (e.g., the number of dwellings, offices, or other units in a structure to which a project pertains) as a twelfth type of project attribute, an attribute-specific set of one or more predictive analytics pipelines for predicting number of units may include a first predictive analytics pipeline that is based on a decision-tree model (e.g., a GBDT model such as an XGBoost model) and/or a second example predictive analytics pipeline that is based on a computer-vision model. These examples of predictive analytics pipelines for predicting number of units will now be described in further detail.

The source data for this first example predictive analytics pipeline for predicting number of units may include drawings that are associated with a given construction project for which number of units is to be predicted. The pre-processing logic for this first example predictive analytics pipeline for predicting number of units may include logic to identify textual elements in the drawings by identifying any searchable text (e.g., stored in ASCII or Unicode encodings) that exists in the drawings and by applying OCR to identify any text that is depicted in image form. Once the textual elements have been identified, the pre-processing logic may include logic to identify textual elements that are likely to be numbers of units. Specifically, the pre-processing logic may include logic to identify textual elements that match a predefined pattern associated with number of units. The predefined pattern may take any of various forms. The pre-processing logic may include logic to exclude any textual elements that do not match the predefined pattern from further consideration as potential numbers of units.

The pre-processing logic may further include logic to, for each given textual element that was not excluded, extract respective contextual data for the given textual element from the respective drawing in which the given textual element is found. The respective contextual data may take many forms. As one possibility, the respective contextual data may include spatial information, linguistic information, and/or relational information. In line with the discussion above, each type of contextual data may take various forms, such as the forms described above with respect to the example pipelines for predicting project title. As one example, the relational data may include information about whether any other textual elements are nearby (e.g., within a threshold distance of) the given textual element and/or whether these nearby textual elements include any words found in a predefined positive-correlation list (e.g., words that are frequently found near number of units in drawings) and how many of these positive-correlation words are nearby. As another example, the linguistic information may include information identifying whether the given textual element includes any predefined stop words (e.g., words that are not typically found near numbers of units in drawings) and/or how many of these stop words are included in the given textual element.

The AI model for this first example predictive analytics pipeline for predicting number of units may be an XGBoost model (e.g., for text classification). The XGBoost model may be trained (e.g., by the back-end computing platform 102) in the manner described above with respect to FIG. 2. The label for each given training instance in the training data for the XGBoost model indicates the number of units for a construction project (e.g., a historical project or a simulated project) corresponding to the given training instance.

Inputs for the XGBoost model (e.g., the feature variables which the XGBoost model is configured to receive as input) may comprise any combination of the contextual data described above for textual elements, such as spatial information, linguistic information, and/or relational information, among other possibilities. The contextual data may, in some instances, be formatted in various ways formats and/or projected into different ranges of values (e.g., by the pre-processing logic) in order to serve as input (e.g., feature values) that will be compatible with the XGBoost model. The formats and value ranges may take various forms. For example, some contextual data may be transformed into a numeric format (e.g., integer, decimal, or fraction) and projected into a predetermined range of values (e.g., a range from zero to one, a range from zero to one hundred, etc.). As another example, some contextual data may be transformed into a categorical format based on predefined categories (e.g., categories for parts of speech, such as noun, verb, preposition, adjective, adverb, definite article, etc.). Other formats and value ranges are also possible.

Outputs of the XGBoost model may include (i) a candidate number of units (which may, for example, be the given textual element or a portion thereof) and (ii) a predicted likelihood that the candidate number of units is the true number of units for the given project in which the drawing that contains the candidate number of units is found.

The post-processing logic for this first example predictive analytics pipeline for predicting number of units may include logic to identify the candidate number of units whose corresponding predicted likelihood is greater than the predicted likelihoods for any of the other candidate numbers of units for the given project.

The post-processing logic may further include logic to output the identified candidate number of units as the predicted number of units. In addition or alternatively, the post-processing logic may further include logic to compare the predicted likelihoods of the candidate numbers of units to a threshold likelihood and output any candidate numbers of units whose predicted likelihood exceeds (or at least equals) the threshold likelihood. If none of the predicted likelihoods of the candidate numbers of units exceeds (or at least equals) the threshold likelihood, the post-processing logic may further include logic to output an indication that none of the candidate numbers of units has a sufficiently high predicted likelihood.

Turning to the second example predictive analytics pipeline for predicting number of units, the source data for this second example predictive analytics pipeline may include a plurality of drawings-specifically, drawings that are floor plans.

The pre-processing logic may include logic to select a set of drawings that are floor plans from a larger set of drawings for a project. The larger set of drawings may include drawings of many different types. The pre-processing logic may include logic to identify drawings that are floor plans based on metadata in the drawings themselves (e.g., metadata that explicitly specifies the drawings are floor plans). For drawings that lack such metadata, the pre-processing logic may include logic to perform OCR and search the OCR text for one or more tokens that are strongly correlated with floor plans (e.g., such as the token “floor plan”). Based on the tokens identified, the pre-processing logic may include logic to include drawings that have many strongly correlated tokens in the set of drawings (and to exclude drawings that lack strongly correlated tokens or that have many tokens that are more strongly correlated with other types of drawings).

The AI model for this second example predictive analytics pipeline for predicting number of units may include a computer-vision model (e.g., a hierarchical vision transformer classification model). The training data for the computer-vision model may comprise a plurality of training instances. Each given training instance may represent a respective project and may include (i) a plurality of drawings that are floor plans included in the respective project and (ii) a label that indicates a location hierarchy for spaces depicted in the plurality of drawings. Unit identifiers are included in the location hierarchy.

The training data may be derived from historical projects and/or simulated projects whose location hierarchies are known (e.g., verified and treated as ground-truth data). The training data includes a plurality of training instances whose labels indicate respective location hierarchies for the historical projects and/or simulated projects.

The computer-vision model may be trained in the following manner. The computer-vision model (i) receives each given training instance as input, (ii) predicts a location hierarchy for the respective project corresponding to the training instance based on the plurality of drawings found in the given training instance, (iii) compares the predicted location hierarchy to the label found in the given training instance, and (iv) adjusts model parameters (e.g., the weights and biases found in different layers of the computer-vision model) within the computer-vision model based on any difference that exists between the predicted location hierarchy and the location hierarchy indicated by the label.

As noted above, the inputs for the computer-vision model may comprise a plurality of drawings that are floor plans. The output of the computer-vision model may comprise a predicted location hierarchy for the given project that corresponds to the inputs.

The post-processing logic for this second example predictive analytics pipeline for predicting number of units may include logic to calculate a respective number of units for the given project based on the predicted location hierarchy. For example, the post-processing logic may include logic to (i) determine the number of units by counting the total number of unique unit identifiers included in the predicted location hierarchy and (ii) output the total number of unique unit identifiers.

In line with the discussion above, in at least some implementations, an attribute-specific set of one or more predictive analytics pipelines for predicting number of units may include the foregoing examples of predictive analytics pipelines for predicting number of units. In such implementations, in operation, the attribute-specific set of one or more predictive analytics pipelines for predicting number of units may function to output multiple predicted values of the number of units-a first candidate number of units that is output by the first example predictive analytics pipeline for predicting number of units and a second candidate number of units that is output by the second example predictive analytics pipeline for predicting number of units. In such implementations, the back-end computing platform 102 may optionally be configured with additional logic for selecting between and/or combining the candidate numbers of units. In other implementations, the back-end computing platform 102 may store the candidate numbers of units and provide an option for a user to select one of the candidate numbers of units above ground manually via a user interface.

Other examples of predictive analytics pipelines for predicting number of units may also be created in accordance with the present disclosure, including but not limited to predictive analytics pipelines that are based on other types of AI models.

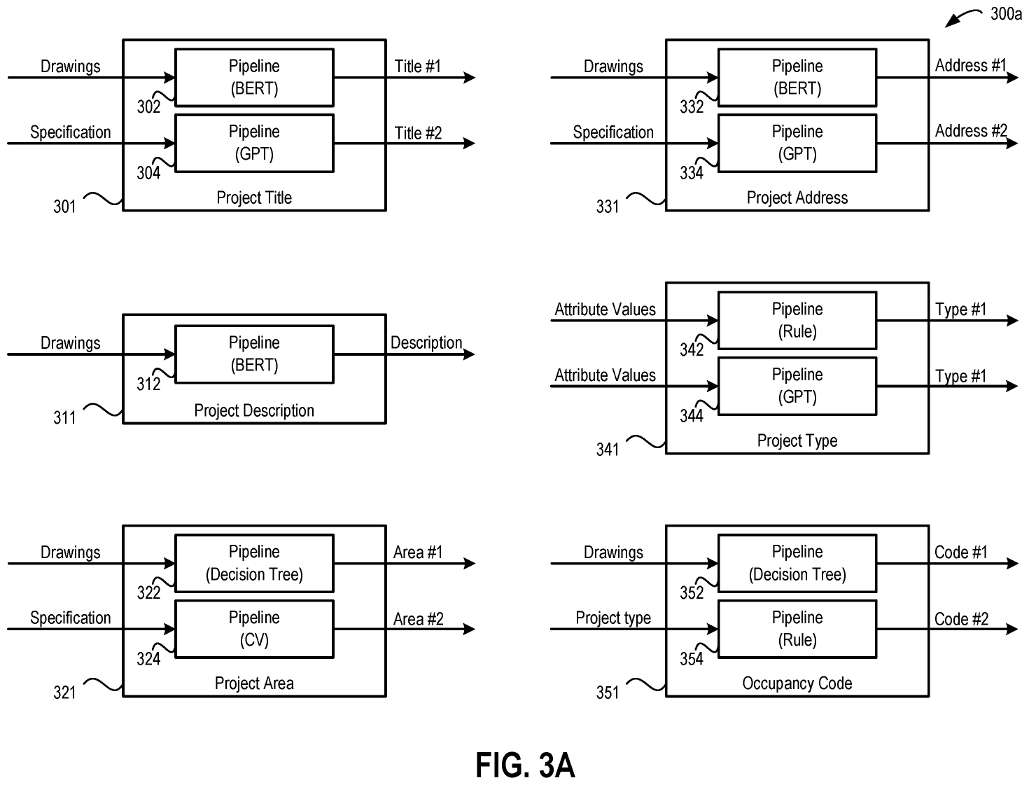

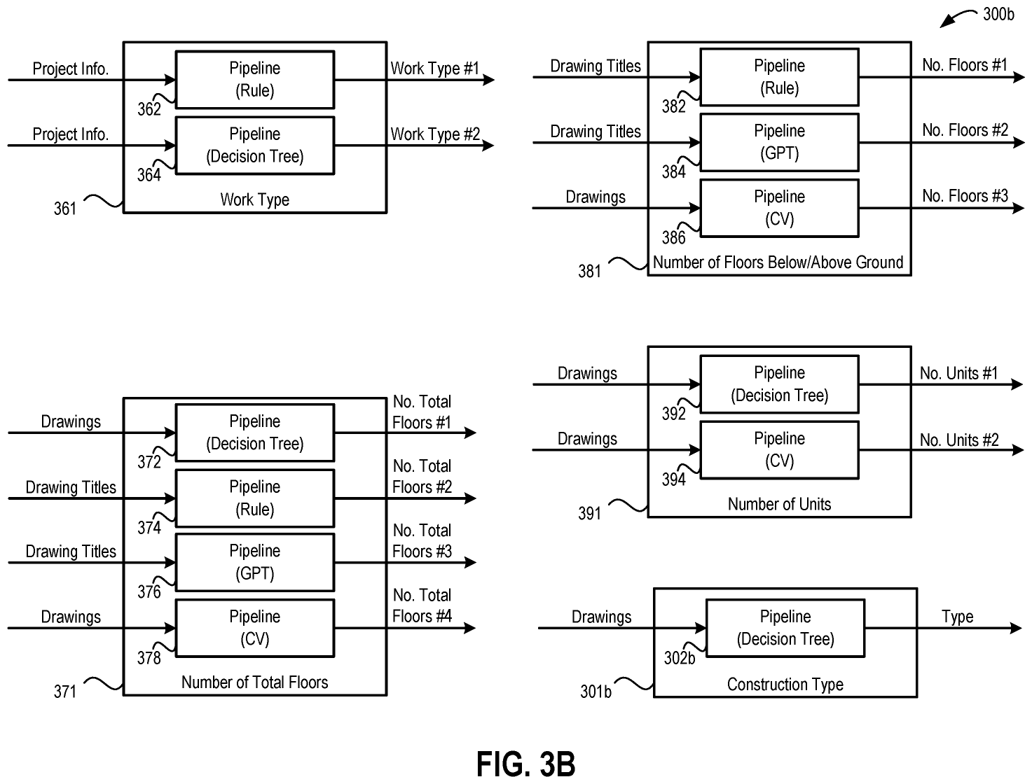

Turning to FIGS. 3A-B, FIG. 3A depicts block diagrams 300a that illustrate the example sets of attribute-specific predictive analytics pipelines described above for predicting for project title, project description, project area, project address, project type, and occupancy code, respectively, according to one example of the present disclosure.

As shown, a set 301 of attribute-specific predictive analytics pipelines for predicting project title includes a predictive analytics pipeline 302 that is based on a BERT model that is configured for text classification and a predictive analytics pipeline 304 that is based on a GPT model that is configured for question answering. The predictive analytics pipeline 302 receives drawings as source data, while the GPT model receives a specification as source data. The predictive analytics pipeline 302 and the predictive analytics pipeline 304 output respective predicted project titles.

A set 311 of attribute-specific predictive analytics pipelines for predicting project description includes a predictive analytics pipeline 312 that is based on a BERT model that is configured for textual similarity. The predictive analytics pipeline 312 receives drawings as source data. The predictive analytics pipeline 312 outputs a predicted project description.

A set 321 of attribute-specific predictive analytics pipelines for predicting project area includes a predictive analytics pipeline 322 that is based on a decision-tree model and a predictive analytics pipeline 324 that is based on a computer-vision (CV) model. Both the predictive analytics pipeline 322 and the predictive analytics pipeline 324 receive drawings as source data. The predictive analytics pipeline 322 and the predictive analytics pipeline 324 output respective predictive project areas.

A set 331 of attribute-specific predictive analytics pipelines for predicting project address includes a predictive analytics pipeline 332 that is based on a BERT model that is configured for text classification and a predictive analytics pipeline 334 that is based on a GPT model that is configured for question answering. The predictive analytics pipeline 332 receives drawings as source data, while the predictive analytics pipeline 334 receives a specification as source data. The predictive analytics pipeline 332 and the predictive analytics pipeline 334 output respective predicted project addresses.

A set 341 of attribute-specific predictive analytics pipelines for predicting project type includes a predictive analytics pipeline 342 that is based on a rule-based model and a predictive analytics pipeline 344 that is based on a GPT model that is configured for question answering. Both the predictive analytics pipeline 342 and the predictive analytics pipeline 344 receive project attribute values as source data. (Note, however, that the project attribute values received by the predictive analytics pipeline 342 as source data do not necessarily have to be identical to the project attribute values received by the predictive analytics pipeline 344 as source data.). The predictive analytics pipeline 342 and the predictive analytics pipeline 344 output respective predicted project types.

A set 351 of attribute-specific analytics pipelines for predicting occupancy code includes a predictive analytics pipeline 352 that is based on a decision-tree model and a predictive analytics pipeline 354 that is based on a rule-based model. The predictive analytics pipeline receives drawings as source data, while the predictive analytics pipeline 354 receives a value for project type as source data. The predictive analytics pipeline 352 and the predictive analytics pipeline 354 output respective predicted occupancy codes.

FIG. 3B depicts block diagrams 300b that illustrate the example sets of attribute-specific predictive analytics pipelines described above for predicting work type, number of total floors, number of floors above ground (or below ground), number of units, and construction type, respectively, according to one example of the present disclosure.

As shown, a set 361 of attribute-specific predictive analytics pipelines for predicting work type includes a predictive analytics pipeline 362 that is based on a rule-based model and a predictive analytics pipeline 364 that is based on a decision-tree model. Both the predictive analytics pipeline 362 and the predictive analytics pipeline 364 receive project information (e.g., values for project attributes) as source data. (Note that the project information received by the predictive analytics pipeline 362 as source data does not necessarily have to be identical to the project information received by the predictive analytics pipeline 364 as source data). The predictive analytics pipeline 362 and the predictive analytics pipeline 364 output respective predicted values for work type.

A set 371 of attribute-specific predictive analytics pipelines for predicting number of total floors includes a predictive analytics pipeline 372 that is based on a decision-tree model, a predictive analytics pipeline 374 that is based on a rule-based model, a predictive analytics pipeline 376 that is based on a GPT model that is configured for question answering, and a predictive analytics pipeline 378 that is based on a computer-vision model. The predictive analytics pipeline 372 and the predictive analytics pipeline 378 both receive drawings as source data. The predictive analytics pipeline 374 and the predictive analytics pipeline 376 both receive drawing titles as source data. Each of the predictive analytics pipeline 372, the predictive analytics pipeline 374, the predictive analytics pipeline 376, and the predictive analytics pipeline 378 outputs a respective predicted number of total floors.

A set 381 of attribute-specific analytics pipelines for predicting number of floors below ground (or, alternatively, above ground) includes a predictive analytics pipeline 382 that is based on a rule-based model, a predictive analytics pipeline 384 that is based on a GPT model that is configured for question answering, and a predictive analytics pipeline 386 that is based on a computer-vision model. The predictive analytics pipeline 382 and the predictive analytics pipeline 384 receive drawing titles as source data, while the predictive analytics pipeline 386 receives drawings as source data. Each of the predictive analytics pipeline 382, the predictive analytics pipeline 384, and the predictive analytics pipeline 386 outputs a respective predicted number of floors below ground (or, alternatively, a respective predicted number of floors above ground).

A set 391 of attribute-specific predictive analytics pipelines for predicting number of units includes a predictive analytics pipeline 392 that is based on a decision-tree model and a predictive analytics pipeline 394 that is based on a computer-vision model. Both the predictive analytics pipeline 392 and the predictive analytics pipeline 394 receive drawings as source data. The predictive analytics pipeline 392 and the predictive analytics pipeline 394 output respective predicted numbers of units.

A set 301b of attribute-specific predictive analytics pipelines for predicting construction type includes a predictive analytics pipeline 302b that is based on a decision-tree model. The predictive analytics pipeline 302b receives drawings as input and outputs a predicted construction type.

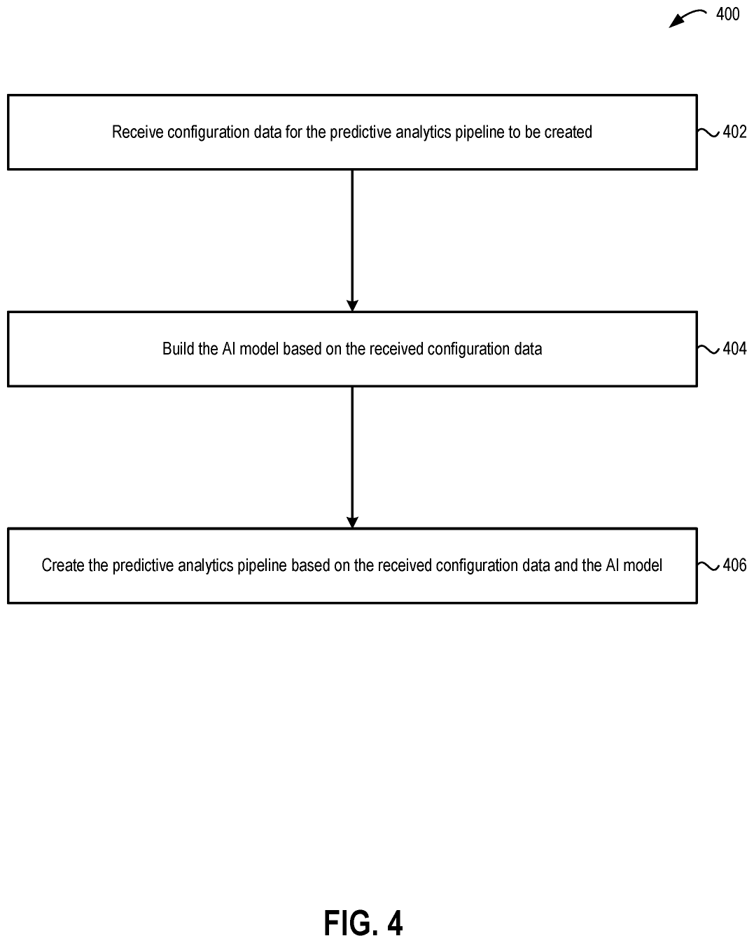

The functionality that may be carried out in order to create a predictive analytics pipeline for a given project attribute may take any of various forms, and one possible implementation of that functionality is illustrated in FIG. 4. For purposes of illustration, the example functionality 400 of FIG. 4 is described as being carried out by the back-end computing platform 102 of FIG. 1, but it should be understood that the example functionality 400 of FIG. 4 may be carried out by any computing platform that is capable of running the software disclosed herein. Further, it should be understood that the example functionality of FIG. 4 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 4, the example functionality 400 may begin at block 402 with the back-end computing platform 102 receiving configuration data for the predictive analytics pipeline to be created. This configuration data could take any of various forms.

As one possibility, the configuration data for the predictive analytics pipeline may include an identification of the given project attribute for which values are to be predicted by the predictive analytics pipeline. In line with the discussion above, the given project attribute could comprise any of various types of attributes that may be determined and stored for a construction project, examples of which may include a project title, a project description, a project address, a project area (including the unit of measurement for the project area), a project type, an occupancy code, a construction type, a work type, a number of total floors, a number of floors above ground, a number of floors below ground, or a number of units, among other possibilities.

As another possibility, the configuration data for the predictive analytics pipeline may include configuration data that specifies the source data for the predictive analytics pipeline. For instance, such configuration data may specify the type(s) of source data that is to be input into the predictive analytics pipeline and/or the data source(s) from which the source data is to be obtained, among other possible ways to specify the source data for the predictive analytics pipeline. To illustrate with some examples, the configuration data may specify that the source data for the predictive analytics pipeline is to include one or more of (i) the drawings that have been uploaded for a construction project (or a particular subset of the drawings that have been uploaded for the construction project), (ii) the specifications that have been uploaded for the construction project (or a particular subset of the specifications that have been uploaded for the construction project), (iii) certain types of project attributes that have been input or otherwise determined for the construction project, and/or (iv) other types of project data that is available for the construction project. In this respect, the source data that is specified may comprise project data that is expected to be stored by the back-end computing platform 102 in connection a construction management software application (i.e., the data source for the project data may be a data store of the back-end computing platform 102) and/or project data that is available from a data source external to the back-end computing platform 102, among other possibilities.

As yet another possibility, the configuration data for the predictive analytics pipeline may include configuration data for the pre-processing logic that is to be included as part of the predictive analytics pipeline. For instance, such configuration data may define the types of pre-processing operations that are to be carried out by the pre-processing logic of the predictive analytics pipeline and the sequence in which the pre-processing operations that are to be carried out, among other possibilities. In line with the discussion above, such pre-processing operations that are defined for the predictive analytics pipeline may take any of various forms, including but not limited to pre-processing operations for applying OCR, joining textual elements, identifying and extracting text elements that meet certain criteria or match certain patterns, performing NER, performing POS tagging, vectorizing textual elements, extracting metadata, and/or extracting contextual information for textual elements (e.g., spatial information, relational information, etc.), among other possibilities.

As still another possibility, the configuration data for the predictive analytics pipeline may include configuration data for the AI model that is to be included as part of the predictive analytics pipeline. For instance, such configuration data may specify the type of AI model to be included as part of the predictive analytics pipeline, which could take the form of an AI model based on a particular type of generative AI model (e.g., a BERT or GPT type of LLM), an AI model based on a particular type of discriminative AI model (e.g., a decision-tree model, a computer-vision model, etc.), or an AI model based on a particular type of rules-based mode, among other possibilities. Additionally, the configuration data for the AI model may include configuration parameters for the AI model, which may vary depending on the type of AI model that is specified. For example, if the AI model is of a type that is pre-trained, the configuration parameters for the AI model may include parameters for accessing the pre-trained AI model, such as an identification of an API for the pre-trained AI model. As another example, if the AI model is of a type that is to be trained or fine-tuned by the back-end computing platform 102, the configuration parameters for the AI model may include parameters for training or fine-tuning the AI model, which could take any of various forms, including but not limited to parameters defining the inputs of the AI model, the output of the AI model, the machine-learning techniques to be used for training or fine-tuning the AI model, and/or hyperparameters to be used for training or fine-tuning the AI model, among other possibilities. As yet another example, if the AI model is a rules-based model, the configuration parameters for the AI model may include parameters defining the rules logic that is to be applied by the AI model. Other examples of configuration parameters for the AI model are possible as well. Additionally yet, if the AI model is of a type that is to be trained or fine-tuned by the back-end computing platform 102, the configuration data for the AI model may include data specifying the training data that is to be used for training or fine-tuning the AI model. The configuration data for the AI model may take other forms as well.

As a further possibility, the configuration data for the predictive analytics pipeline may include configuration data for the post-processing logic (if any) that is to be included as part of the predictive analytics pipeline. For instance, such configuration data may define the types of post-processing operations that are to be carried out by the post-processing logic of the predictive analytics pipeline and the sequence in which the post-processing operations that are to be carried out, among other possibilities. In line with the discussion above, such post-processing operations that are defined for the predictive analytics pipeline may take any of various forms, including but not limited to post-processing operations for selecting between candidate values for the given project attribute, transforming, cleaning, or completing the output of the AI model, and/or performing additional operations on the output of the AI model (e.g., additional calculations, lookup operations, etc.), among other possibilities. Further, in line with the discussion above, it is also possible that certain configurations of predictive analytics pipelines will not include any post-processing logic, such as configurations where the pipeline's AI model outputs a single, predicted value for the given project attribute and that predicted value is in a form that does not require any further processing in order to be utilized as the value of the given project attribute.

The configuration data for the predictive analytics pipeline that is received by the back-end computing platform 102 may take various other form as well.

Further, the manner in which the back-end computing platform 102 receives the configuration data for the predictive analytics pipeline may take various forms. For instance, as one possibility, the back-end computing platform 102 may provide an interface that can be accessed and used by individuals tasked with creating predictive analytics pipelines to input configuration data for the predictive analytics pipeline. For example, an individual tasked with creating the predictive analytics pipeline may direct a client device to access the interface provided by the back-end computing platform 102 and then input configuration data for the predictive analytics pipeline into the interface, which may then cause the client device to transmit the configuration data to the back-end computing platform 102 over a network-based communication path. Such an interface provided by the back-end computing platform 102 may take any of various forms, including but not limited to an interface that enables a user to input configuration data for the predictive analytics pipeline in the form of parameterized variables and/or source code, among other possibilities. The back-end computing platform 102 may receive the configuration data for the predictive analytics pipeline in other ways as well.

At block 404, if the pipeline's AI model is of a type that is to be built by the back-end computing platform 102 (as opposed to a pre-trained, non-fine-tuned model, for example), then the back-end computing platform 102 may build the AI model based on the received configuration data for the AI model. Depending on the type of AI model, this functionality may take various forms.

For instance, if the pipeline's AI model is of a type that is to be fine-tuned or trained by the back-end computing platform 102, then the back-end computing platform 102 may carry out a fine-tuning or training process for the AI model based on the received configuration data for the AI model. Such a training or fine-tuning process may take any of various forms, which may depend on the type of AI model to be included in the predictive analytics pipeline. For example, if the AI model to be included in predictive analytics pipeline is a pre-trained model that is to be fine-tuned for predicting the value of the given project attribute (e.g., a pre-trained LLM such a BERT or GPT model or a pre-trained computer-vision model), the back-end computing platform 102 may carry out a fine-tuning process for the pre-trained model in order to tailor it for use in predicting the value of the given project attribute. (However, in line with the discussion above, it is also possible that the AI model to be included in predictive analytics pipeline is a pre-trained model that is not fine-tuned). As another example, if the AI model to be included in predictive analytics pipeline is a model that is to be trained to predict the value of the given project attribute in the first instance (e.g., a decision-tree model, a non-pre-trained computer-vision model, etc.), the back-end computing platform 102 may carry out a training process for the AI model based on the received configuration data for the AI model. Other examples are possible as well.

On the other hand, if the pipeline's AI model is a rules-based model that encodes rules logic input by a user, then the back-end computing platform 102 may build the rules-based model based on the rules logic specified by the received configuration data for the AI model.

The functionality for building the AI model of a predictive analytics pipeline may take various other forms as well.

At block 406, the back-end computing platform 102 may create the predictive analytics pipeline based on the received configuration data and the AI model for the predictive analytics pipeline (which as noted above may either be a pre-trained, non-fine-tuned AI model or may be an AI model that is built by the back-end computing platform 102). In general, this functionality for creating the predictive analytics pipeline may involve generating executable program code that embodies the predictive analytics pipeline, where that executable program code, when executed for a given construction project, causes the back-end computing platform 102 to (i) obtain source data of the specified types(s) for the given construction project, (ii) apply the pipeline's pre-processing logic to the obtained source data for the given construction project and thereby derive input data for the AI model, (iii) provide the derived input data as input to the pipeline's AI model and thereby cause the AI model to be executed based on the input data, (iv) based on the prediction output by the AI model, determine and output a predicted value of the given project attribute for the given construction project, which may optionally involve applying post-processing logic to the prediction output by the AI model. However, the functionality for creating the predictive analytics pipeline may take various other forms as well.

In line with the discussion above, the foregoing functionality may be utilized to create an attribute-specific set of one or more predictive analytics pipelines for each of one or more project attributes of interest. For instance, the back-end computing platform 102 (or some other computing platform) may be configured to create a first attribute-specific set of one or more predictive analytics pipelines for a first project attribute of interest (e.g., project title), a second attribute-specific set of one or more predictive analytics pipelines for a second project attribute of interest (e.g., project description), and so on. In this respect, the back-end computing platform 102 (or some other computing platform) may carry out a respective instance of the foregoing functionality for each predictive analytics pipeline that is to be created for each project attribute of interest.

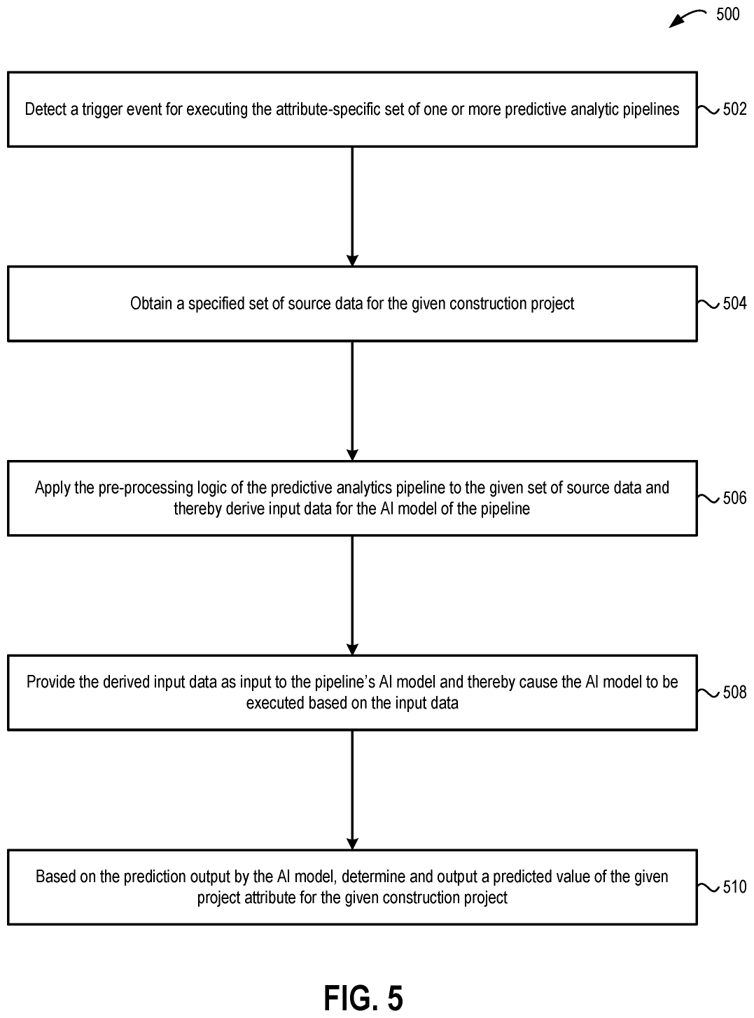

After an attribute-specific set of one or more predictive analytics pipelines has been created for a given project attribute, the functionality that may be carried out in order to predict one or more values for the given project attribute utilizing the attribute-specific set of one or more predictive analytics pipelines may take any of various forms, and one possible implementation of that functionality is illustrated in FIG. 5. For purposes of illustration, the example functionality 500 of FIG. 5 is described as being carried out by the back-end computing platform 102 of FIG. 1, but it should be understood that the example functionality 500 of FIG. 5 may be carried out by any computing platform that is capable of running the software disclosed herein-including but not limited to the possibility that the computing platform that carries out the functionality 500 of FIG. 5 differs from the computing platform that carries out the functionality 400 of FIG. 4. Further, it should be understood that the example functionality of FIG. 5 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 5, the example functionality 500 may begin at block 502 with the back-end computing platform 102 detecting a trigger event for executing the attribute-specific set of one or more predictive analytics pipelines in order to predict one or more values of the given project attribute for a given construction project. This trigger event may take any of various forms. As one possibility, the trigger event for executing the attribute-specific set of one or more predictive analytics pipelines may comprise a request that is received from a user's client device 112 via a network-based communication path 110. For example, a construction management software application that being accessed by the user's client device may present the user with an option to request that the project attribute data for the given construction project be updated, which could take the form of either a global request to update multiple project attributes or a targeted request to update a specific project attribute, and if the user inputs such a request, the user's client device 112 may then send a data communication indicating the request to the back-end computing platform 102 via a network-based communication path 110.

As another possibility, the trigger event for executing the attribute-specific set of one or more predictive analytics pipelines may comprise a time-based event. For instance, the back-end computing platform 102 could be configured to periodically run the attribute-specific set of one or more predictive analytics pipelines for the given project attribute in accordance with a schedule or the like (e.g., once a week, once a month, etc.), in which case the trigger event may comprise a particular time indicated by the schedule.

As yet another possibility, the trigger event for executing the attribute-specific set of one or more predictive analytics pipelines may comprise an update to certain types of project data for the given construction project. For instance, the back-end computing platform 102 could be configured to monitor for updates to certain types of project data that is utilized as source data for the attribute-specific set of one or more predictive analytics pipelines, and if the back-end computing platform 102 detects an update (e.g., an upload of a new drawing or specification or an update to some other project attributes), the back-end computing platform 102 may then re-run the attribute-specific set of one or more predictive analytics pipelines.

The trigger event for executing the attribute-specific set of one or more predictive analytics pipelines may take various other forms as well.

In response to detecting such a trigger event, the back-end computing platform 102 may execute the attribute-specific set of one or more predictive analytics pipelines in order to predict one or more values of the given project attribute for a given construction project, which may involve carrying out various functionality in accordance with the attribute-specific set of one or more predictive analytics pipelines. For purposes of illustration, this functionality will be described below with reference to one respective predictive analytics pipeline for the given project attribute, but if the attribute-specific set of one or more predictive analytics pipelines includes multiple predictive analytics pipelines, then the back-end computing platform 102 may carry out a respective instance of the following functionality for each of the multiple predictive analytics pipelines. In this respect, the back-end computing platform 102 could carry out the multiple instances of the pipeline functionality either in series (e.g., by completing the pipeline functionality for a first predictive analytics pipeline before beginning the functionality pipeline for a second predictive analytics pipeline, and so on) or at least partially in parallel.

The functionality for executing the respective predictive analytics pipeline for the given project attribute may begin at block 504 with the back-end computing platform 102 obtaining a specified set of source data for the given construction project, which could take any of various forms depending on the configuration of the predictive analytics pipeline. For instance, in line with the discussion above, the specified set of source data that is obtained for the given construction project may include one or more of (i) the drawings that have been uploaded for given construction project (or a particular subset of the drawings that have been uploaded for the given construction project), (ii) the specifications that have been uploaded for the given construction project (or a particular subset of the specifications that have been uploaded for the given construction project), (iii) certain types of project attributes that have been input or otherwise determined for the given construction project, and/or (iv) other types of project data that is available for the given construction project. Further, in line with the discussion above, the function of obtaining the specified set of source data for the given construction project may involve retrieving the source data from one or more data stores of the back-end computing platform 102 and/or requesting and receiving the source data from one or more external data sources, among other possibilities.

At block 506, after obtaining the given set of source data for the given construction project, the back-end computing platform 102 may apply the pre-processing logic of the predictive analytics pipeline to the given set of source data for the given construction project and thereby derive input data for the AI model of the predictive analytics pipeline. In line with the discussion above, this function of applying the pre-processing logic of the predictive analytics pipeline may involve carrying out one or more types of pre-processing operations on the given set of source data, examples of which may include applying OCR, joining textual elements, identifying and extracting text elements that meet certain criteria or match certain patterns, performing NER, performing POS tagging, vectorizing textual elements, extracting metadata, and/or extracting contextual information for textual elements (e.g., spatial information, relational information, etc.), among other possibilities.

At block 508, after deriving the input data for the AI model of the predictive analytics pipeline, the back-end computing platform 102 may provide the derived input data as input to the pipeline's AI model and thereby cause the AI model to be executed based on the input data. For instance, if the AI model of the predictive analytics pipeline is hosted locally on the back-end computing platform 102 itself, then this function may involve inputting the derived input data into the locally hosted AI model and then executing the locally hosted AI model in order to cause the AI model to output a prediction based on the input data. Alternatively, if the AI model of the predictive analytics pipeline is hosted remotely on an external computing platform (e.g., a computing platform configure to host a pre-trained model), then this function may involve transmitting the derived input data to the external computing platform via a network-based communication path along with a request to execute the remotely hosted AI model based on the derived input data (e.g., an API request message comprising a prompt), which may cause the external computing platform to input the derived input data into the remotely hosted AI model and then execute the remotely hosted AI model in order to cause the AI model to output a prediction based on the input data that is then returned to the back-end computing platform 102 via the network-based communication path as a response to the back-end computing platform request (e.g., an API response). The function of causing the AI model to be executed based on the input data may take other forms as well.

At block 510, based on the prediction output by the AI model, the back-end computing platform 102 may determine and output a predicted value of the given project attribute for the given construction project. Depending on the configuration of the predictive analytics pipeline, this functionality may take various forms.

For example, if the AI model of the predictive analytics pipeline outputs a prediction that takes the form of a set of candidate values for the given project attribute, the functionality of determining and outputting the predicted value of the given project attribute for the given construction project may involve applying post-processing logic of the predictive analytics pipeline that is configured to select one given value from the set of candidate values (e.g., the candidate value having the highest confidence score) and perhaps also perform one or more other post-processing operations on the selected value (e.g., transforming, cleaning, or completing the value).

As another example, if the AI model of the predictive analytics pipeline outputs a prediction that takes the form of a single, predicted value for the given project attribute, the functionality of determining and outputting the predicted value of the given project attribute for the given construction project may involve simply selecting and outputting that one predicted value as the predicted value of the given project attribute for the given construction project and/or may involve applying post-processing logic of the predictive analytics pipeline that is configured to transform, clean, and/or complete the value.

As yet another example, if the AI model of the predictive analytics pipeline outputs a prediction that takes the form of one or more intermediate values that are to be utilized to determine the predicted value of the given project attribute, the functionality of determining and outputting the predicted value of the given project attribute for the given construction project may involve applying post-processing logic of the predictive analytics pipeline that is configured to applying one or more additional operations in order to determine the predicted value of the given project attribute based on the one or more intermediate values output by the AI model.

The functionality of determining and outputting the predicted value of the given project attribute for the given construction project based on the prediction output by the AI model may take various other forms as well.

After executing the attribute-specific set of one or more predictive analytics pipelines in order to predict one or more values of the given project attribute for a given construction project, the back-end computing platform 102 may then take any of various actions with respect to the one or more values of the given project attribute that are predicted for the given construction project.

As one possibility, the back-end computing platform 102 may update the project attribute data for the given construction project based on the one or more values of the given project attribute that are predicted for the given construction project. For instance, if the back-end computing platform 102 has predicted a single value of the given project attribute (e.g., based on a single predictive analytics pipeline), the back-end computing platform 102 may overwrite the stored value of the given project attribute with that predicted value. On the other hand, if the back-end computing platform 102 has predicted multiple values of the given project attribute (e.g., based on multiple predictive analytics pipelines), the back-end computing platform 102 may either (i) overwrite the stored value of the given project attribute with both predicted values, (ii) apply additional logic that is configured to select between the predicted values of the given project attribute and then overwrite the stored value of the given project attribute with the selected value, or (iii) apply additional logic that is configured to combine the predicted values of the given project attribute into a single combined value (e.g., by aggregating the values in some way) and then overwrite the stored value of the given project attribute with the combined value. The function of updating the project attribute data for the given construction project based on the one or more values of the given project attribute that are predicted for the given construction project may take other forms as well.

As another possibility, the back-end computing platform 102 may use the one or more values of the given project attribute that are predicted for the given construction project as input for some other downstream process, such as another predictive analytics pipeline.

The back-end computing platform 102 may use the one or more values of the given project attribute that are predicted for the given construction project for other purposes as well.

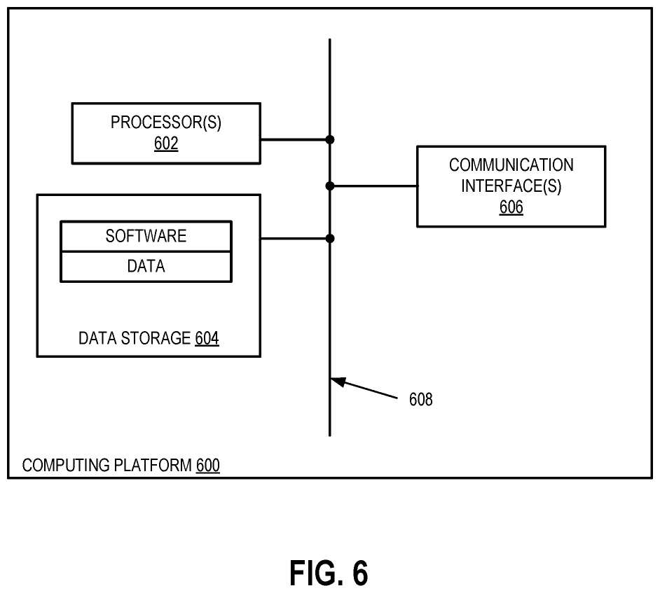

Turning now to FIG. 6, a simplified block diagram is provided to illustrate some structural components that may be included in an example computing platform 600 that may be configured to perform the platform-side functions disclosed herein. At a high level, the example computing platform 600 may generally comprise any one or more computer systems (e.g., one or more servers) that collectively include one or more processors 602, data storage 604, and one or more communication interfaces 606, each of which may be communicatively linked by a communication link 608 that may take the form of a system bus, a communication network such as a public, private, or hybrid cloud, or some other connection mechanism. Each of these components may take various forms.

For instance, the one or more processors 602 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 602 could comprise processing components that are distributed across a plurality of physical computing devices connected via a network, such as a computing cluster of a public, private, or hybrid cloud.

In turn, the data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, the data storage 604 may be capable of storing both (i) program instructions that are executable by the one or more processors 602 such that the example computing platform 600 is configured to perform any of the various functions disclosed herein (including but not limited to any of the server-side functions discussed above), and (ii) data that may be received, derived, or otherwise stored by the example computing platform 600.

The one or more communication interfaces 606 may comprise one or more interfaces that facilitate communication between the example computing platform 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB (Universal Serial Bus) 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 600 may additionally have an Input/Output (I/O) interface that includes or provides connectivity to I/O components that facilitate user interaction with the example computing platform 600, such as a keyboard, a mouse, a trackpad, a display screen, a touch-sensitive interface, a stylus, a virtual-reality headset, and/or one or more speaker components, among other possibilities.

It should be understood that the example computing platform 600 is one example of a computing platform that may be used with the examples described herein. Numerous other arrangements are possible and contemplated herein. For instance, in other examples, the example computing platform 600 may include additional components not pictured and/or more or less of the pictured components.

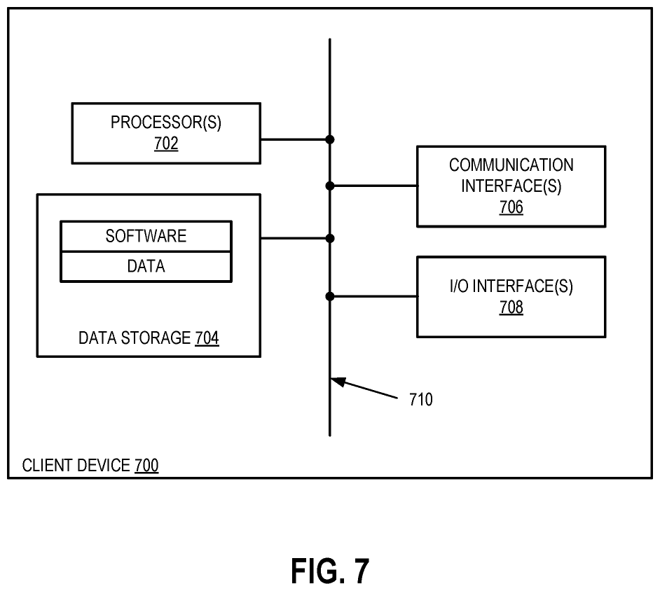

Turning next to FIG. 7, a simplified block diagram is provided to illustrate some structural components that may be included in an example client device 700 that may be configured to perform some the client-side functions disclosed herein. At a high level, the example client device 700 may include one or more processors 702, data storage 704, one or more communication interfaces 706, and an I/O interface 708, each of which may be communicatively linked by a communication link 710 that may take the form a system bus and/or some other connection mechanism. Each of these components may take various forms.

For instance, the one or more processors 702 of the example client device 700 may comprise one or more processor components, such as one or more CPUs, GPUs, ASICs, DSPs, and/or programmable logic devices such as FPGAs, among other possible types of processing components.

In turn, the data storage 704 of the example client device 700 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 7, the data storage 704 may be capable of storing both (i) program instructions that are executable by the one or more processors 702 of the example client device 700 such that the example client device 700 is configured to perform any of the various functions disclosed herein (including but not limited to any of the client-side functions discussed above), and (ii) data that may be received, derived, or otherwise stored by the example client device 700.

The one or more communication interfaces 706 may comprise one or more interfaces that facilitate communication between the example client device 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 708 may generally take the form of (i) one or more input interfaces that are configured to receive and/or capture information at the example client device 700 and (ii) one or more output interfaces that are configured to output information from the example client device 700 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 708 may include or provide connectivity to output components such as a display screen and/or an audio speaker, among other possibilities.

It should be understood that the example client device 700 is one example of a client device that may be used with the examples described herein. Numerous other arrangements are possible and contemplated herein. For instance, in other examples, the example client device 700 may include additional components not pictured and/or more or fewer of the pictured components.

Examples of the disclosed innovations have been described above. Those skilled in the art will understand, however, that changes and modifications may be made to the examples described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one communication interface;
at least one processor;
at least one non-transitory computer-readable medium; and
program instructions stored on the at least one non-transitory computer-readable medium that, when executed by the at least one processor, cause the computing platform to:
detect a trigger event for determining a value of a given project attribute for a given construction project having a stored set of project attribute data;
in response to detecting the trigger event, execute an attribute-specific set of one or more predictive analytics pipelines for predicting one or more values of the given project attribute, wherein each respective predictive analytics pipeline in the attribute-specific set of one or more predictive analytics pipelines comprises (i) respective pre-processing logic and (ii) a respective artificial intelligence (AI) model, and wherein each respective predictive analytics pipeline in the attribute-specific set of one or more predictive analytics pipelines, when executed, functions to:
obtain a respective set of source data for the given construction project;
apply the respective pre-processing logic of the respective predictive analytics pipeline to the respective set of source data for the given construction project and thereby derive a respective set of input data for the respective AI model of the respective predictive analytics pipeline;
provide the respective set of input data as input to the respective AI model of the respective predictive analytics pipeline and thereby cause the respective AI model to output a respective prediction based on the respective set of input data; and
based on the respective prediction that is output by the respective AI model of the respective predictive analytics pipeline, determine and output a respective value of the given project attribute for the given construction project; and
update the stored set of project attribute data for the given construction project based on the one or more values of the given project attribute that are predicted for the given construction project.

2. The computing platform of claim 1, wherein the given project attribute comprises one of (i) a project title, (ii) a project description, (iii) a project address, (iv) a project area, (v) a project type, (vi) an occupancy code, (vii) a construction type, (viii) a work type, (ix) a number of total floors, (x) a number of floors above ground, (xi) a number of floors below ground, or (xii) a number of units.

3. The computing platform of claim 1, wherein, for each respective predictive analytics pipeline in the attribute-specific set of one or more predictive analytics pipelines, the respective set of source data comprises at least one of (i) a set of one or more drawings for the given construction project, (ii) set of one or more specifications for the given construction project, or (iii) one or more types of project attributes data for the given construction project.

4. The computing platform of claim 1, wherein, for each respective predictive analytics pipeline in the attribute-specific set of one or more predictive analytics pipelines, the respective pre-processing logic comprises at least one of (i) pre-processing logic for extracting textual elements from a set of one or more drawings or (ii) pre-processing logic for extracting textual elements from a set of one or more specifications.

5. The computing platform of claim 1, wherein, for each respective predictive analytics pipeline in the attribute-specific set of one or more predictive analytics pipelines, the respective AI model comprises an AI model that is based on one of (i) a generative artificial intelligence (AI) model, (ii) a discriminative AI model, or (iii) a rules-based model.

6. The computing platform of claim 5, wherein the generative AI model comprises either a Bidirectional Encoder Representations from Transformers (BERT) model or a Generative Pre-trained Transformer (GPT) model.

7. The computing platform of claim 5, wherein the generative AI model comprises a pre-trained model that has been fine-tuned for predicting a value of the given project attribute based on training data.

8. The computing platform of claim 5, wherein the discriminative AI model comprises either a decision-tree model or a computer-vision model that has been trained using a machine-learning process.

9. The computing platform of claim 1, wherein the respective AI model for at least one respective predictive analytics pipeline in the attribute-specific set of one or more predictive analytics pipelines is remotely hosted by a separate computing platform.

10. The computing platform of claim 1, wherein the attribute-specific set of one or more predictive analytics pipelines comprises multiple predictive analytics pipelines that are each configured to predict a respective value of the given project attribute, wherein the multiple predictive analytics pipelines comprise different types of AI models.

11. The computing platform of claim 1, wherein at least one respective predictive analytics pipeline in the attribute-specific set of one or more predictive analytics pipelines comprises respective post-processing logic that is to be applied to the respective prediction output by the respective AI model of the at least one respective predictive analytics pipeline.

12. A non-transitory computer-readable medium, wherein the non-transitory computer-readable medium is provisioned with program instructions that, when executed by at least one processor, cause a computing platform to:
detect a trigger event for determining a value of a given project attribute for a given construction project having a stored set of project attribute data;
in response to detecting the trigger event, execute an attribute-specific set of one or more predictive analytics pipelines for predicting one or more values of the given project attribute, wherein each respective predictive analytics pipeline in the attribute-specific set of one or more predictive analytics pipelines comprises (i) respective pre-processing logic and (ii) a respective artificial intelligence (AI) model, and wherein each respective predictive analytics pipeline in the attribute-specific set of one or more predictive analytics pipelines, when executed, functions to:
obtain a respective set of source data for the given construction project;
apply the respective pre-processing logic of the respective predictive analytics pipeline to the respective set of source data for the given construction project and thereby derive a respective set of input data for the respective AI model of the respective predictive analytics pipeline;
provide the respective set of input data as input to the respective AI model of the respective predictive analytics pipeline and thereby cause the respective AI model to output a respective prediction based on the respective set of input data; and
based on the respective prediction that is output by the respective AI model of the respective predictive analytics pipeline, determine and output a respective value of the given project attribute for the given construction project; and
update the stored set of project attribute data for the given construction project based on the one or more values of the given project attribute that are predicted for the given construction project.

13. The non-transitory computer-readable medium of claim 12, wherein the given project attribute comprises one of (i) a project title, (ii) a project description, (iii) a project address, (iv) a project area, (v) a project type, (vi) an occupancy code, (vii) a construction type, (viii) a work type, (ix) a number of total floors, (x) a number of floors above ground, (xi) a number of floors below ground, or (xii) a number of units.

14. The non-transitory computer-readable medium of claim 12, wherein, for each respective predictive analytics pipeline in the attribute-specific set of one or more predictive analytics pipelines, the respective set of source data comprises at least one of (i) a set of one or more drawings for the given construction project, (ii) set of one or more specifications for the given construction project, or (iii) one or more types of project attributes data for the given construction project.

15. The non-transitory computer-readable medium of claim 12, wherein, for each respective predictive analytics pipeline in the attribute-specific set of one or more predictive analytics pipelines, the respective pre-processing logic comprises at least one of (i) pre-processing logic for extracting textual elements from a set of one or more drawings or (ii) pre-processing logic for extracting textual elements from a set of one or more specifications.

16. The non-transitory computer-readable medium of claim 12, wherein, for each respective predictive analytics pipeline in the attribute-specific set of one or more predictive analytics pipelines, the respective AI model comprises an AI model that is based on one of (i) a generative artificial intelligence (AI) model, (ii) a discriminative AI model, or (iii) a rules-based model.

17. The non-transitory computer-readable medium of claim 16, wherein the generative AI model comprises either a Bidirectional Encoder Representations from Transformers (BERT) model or a Generative Pre-trained Transformer (GPT) model.

18. The non-transitory computer-readable medium of claim 16, wherein the generative AI model comprises a pre-trained model that has been fine-tuned for predicting a value of the given project attribute based on training data.

19. The non-transitory computer-readable medium of claim 16, wherein the discriminative AI model comprises either a decision-tree model or a computer-vision model that has been trained using a machine-learning process.

20. A method comprising:
detecting a trigger event for determining a value of a given project attribute for a given construction project having a stored set of project attribute data;
in response to detecting the trigger event, executing an attribute-specific set of one or more predictive analytics pipelines for predicting one or more values of the given project attribute, wherein each respective predictive analytics pipeline in the attribute-specific set of one or more predictive analytics pipelines comprises (i) respective pre-processing logic and (ii) a respective artificial intelligence (AI) model, and wherein each respective predictive analytics pipeline in the attribute-specific set of one or more predictive analytics pipelines, when executed, functions to:
obtain a respective set of source data for the given construction project;
apply the respective pre-processing logic of the respective predictive analytics pipeline to the respective set of source data for the given construction project and thereby derive a respective set of input data for the respective AI model of the respective predictive analytics pipeline;
provide the respective set of input data as input to the respective AI model of the respective predictive analytics pipeline and thereby cause the respective AI model to output a respective prediction based on the respective set of input data; and
based on the respective prediction that is output by the respective AI model of the respective predictive analytics pipeline, determine and output a respective value of the given project attribute for the given construction project; and
updating the stored set of project attribute data for the given construction project based on the one or more values of the given project attribute that are predicted for the given construction project.
